(19) United States
(12) Patent Application Publication
(10) Pub. No.: US 2024/0042617 A1
(43) Pub. Date: Feb. 8, 2024

(54) INFORMATION PROCESSING DEVICE, MODIFICATION SYSTEM, INFORMATION PROCESSING METHOD, AND NON-TRANSITORY COMPUTER-READABLE MEDIUM

(71) Applicant: NEC Corporation, Minato-ku, Tokyo (JP)

(72) Inventors: Shuntaro SAKURAI, Tokyo (JP); Takehiro ITOU, Tokyo (JP)

(73) Assignee: NEC Corporation, Minato-ku, Tokyo (JP)

(21) Appl. No.: 18/266,859

(22) PCT Filed: Mar. 23, 2021
(86) PCT No.: PCT/JP2021/012014

§ 371 Date: Jun. 13, 2023

(51) Int. Cl. B25J 9/16

(52) U.S. Cl. CPC B25J 9/1697; B25J 9/1664; B25J 9/1682

(57) ABSTRACT

A purpose of the present disclosure is to provide an information processing device and the like that are capable of acquiring an attribute of an object in an operation space of a robot. An information processing device includes an input reception unit configured to receive an input for modifying an operation sequence for a robot; an object information acquisition unit configured to acquire object information indicating information on an object or a virtual object in an operation space of the robot; and an attribute information acquisition unit configured to acquire attribute information relating to the object or the virtual object, based on the input via the input reception unit.

### TECHNICAL FIELD

The present disclosure relates to an information processing device, a modification system, an information processing method, and a non-transitory computer-readable medium, for executing processing of modifying an operation plan of a robot.

### BACKGROUND ART

When an operation of a robot along an optimal path is reproduced by an actual device, there is a case where a behavior different from an operation normally assumed by a person is exhibited. For example, when such an optimal path that a tip portion of an arm avoids a plurality of obstacles is generated, it is assumed that a part other than the tip portion of the arm collides, or an overload is applied due to magnitude of an attitude change of the arm. In addition, when the arm operates while holding some object, there is a possibility of occurrence of such a situation that the held object collides with a person, an animal, or an object around the held object. After an optimal operation plan of the robot is generated in this manner, such a function as to visualize the operation and to enable a person to modify the operation is needed.

Patent Literature 1 discloses a variable modification method of modifying a position variable of a robot control program generated by offline programming. Patent Literature 2 discloses a robot system that drives and controls a robot by a selectively input program like a palettizing system, and handles a predetermined product (hereinafter referred to as “work”) by this robot. Patent Literature 3 discloses a simulation method for a robot operation, which performs programming by simulating an operation of an industrial robot by using a robot simulator. Patent Literature 4 discloses a simulation method for a robot operation, which performs programming by simulating an operation of an industrial robot by using a robot simulator.

### CITATION LIST

### Patent Literature

Patent Literature 1: Japanese Unexamined Patent Application Publication No. S62-106507
Patent Literature 2: Japanese Unexamined Patent Application Publication No. H07-214485
Patent Literature 3: Japanese Unexamined Patent Application Publication No. H08-328632
Patent Literature 4: Japanese Unexamined Patent Application Publication No. 2013-136123

### SUMMARY OF INVENTION

### Technical Problem

However, in the techniques according to Patent Literatures 1 to 4 described above, when an operation sequence of the robot is modified, attributes relating to an object in an operation space of the robot cannot be properly acquired. Such attributes may become a constraint condition to an operation of the robot, but there is a case where some of the attributes relating to the object are difficult to be exactly determined even by various sensors such as a camera.

The present disclosure has been made in order to solve the above problem, and one of objects of the present disclosure is to provide an information processing device, a modification system, an information processing method, and the like that are capable of acquiring an attribute of an object in an operation space of a robot, when modifying an operation sequence of the robot.

### Solution to Problem

An information processing device according to a first example aspect of the present disclosure includes:
an input reception unit configured to receive an input for modifying an operation sequence for a robot;
an object information acquisition unit configured to acquire object information indicating information on an object or a virtual object in an operation space of the robot; and
an attribute information acquisition unit configured to acquire attribute information relating to the object or the virtual object, based on the input via the input reception unit.

A modification system according to a second example aspect of the present disclosure includes:
a sequence display unit configured to display an operation sequence of a robot;
an input reception unit configured to receive an input for modifying an operation sequence for a robot in regard to the display result;
a control signal processing unit configured to transmit a control signal of the operation sequence to the robot, based on the input;
an object information acquisition unit configured to acquire object information indicating information on an object or a virtual object in an operation space of the robot;
an attribute information acquisition unit configured to acquire attribute information relating to the object or the virtual object, based on the input via the input reception unit;
an attribute signal generation unit configured to combine the object information and the attribute information, and generate an attribute signal in which the object information and the attribute information are combined; and
an attribute information processing unit configured to receive the attribute signal that is generated by the attribute signal generation unit and includes information of a combination of an object and an attribute, and generate modification information for modifying an abstract state indicating an operation space of a robot, based on the attribute signal and storage information being stored.

An information processing method according to a third example aspect of the present disclosure includes:
receiving an input for modifying an operation sequence for a robot;
acquiring object information indicating information on an object or a virtual object in an operation space of the robot; and
acquiring attribute information relating to the object or the virtual object, based on the input.

A non-transitory computer-readable medium storing a program according to a fourth example aspect of the present disclosure causes a computer to execute:
processing of receiving an input for modifying an operation sequence for a robot;
processing of acquiring object information indicating information on an object or a virtual object in an operation space of the robot; and
processing of acquiring attribute information relating to the object or the virtual object, based on the input.

An information processing device according to a fifth example aspect of the present disclosure is configured to:
display a space in which a robot operates, and a plurality of attribute candidates relating to an object or a virtual object in the space; and
set an attribute candidate being selected from the plurality of attribute candidates as an attribute of the object or the virtual object.

### Advantageous Effects of Invention

According to the present disclosure, there can be provided an information processing device, a modification system, an information processing method, and the like that are capable of acquiring an attribute of an object in an operation space of a robot.

### BRIEF DESCRIPTION OF DRAWINGS

FIG. 1 illustrates a functional block diagram of an information processing device according to a first example embodiment;

FIG. 2 is a flowchart illustrating an information processing method according to the first example embodiment;

FIG. 3 illustrates a functional block diagram of a modification device according to a second example embodiment;

FIG. 4 is a flowchart illustrating a modification method according to the second example embodiment;

FIG. 5 illustrates a configuration of a robot control system;

FIG. 6 illustrates a hardware configuration of a robot controller;

FIG. 7 illustrates a hardware configuration of a sequence processing device;

FIG. 8 illustrates an example of a data structure of application information;

FIG. 9 illustrates an example of a functional block diagram of the robot controller;

FIG. 10 illustrates an example of a functional block diagram of the sequence processing device;

FIG. 11 illustrates an example of a bird's-eye view of an operation space;

FIG. 12 illustrates an example of a plan display screen before a sequence process in a third example embodiment;

FIG. 13 illustrates an example of a plan display screen during the sequence process in the third example embodiment;

FIG. 14 illustrates an example of a plan display screen after the sequence process in the third example embodiment;

FIG. 15 illustrates an example of a plan display screen after the sequence process in the third example embodiment;

FIG. 16 illustrates an example of blocks of a target logical expression generation unit;

FIG. 17 is an example of a flowchart illustrating an outline of a modification process executed by a sequence processing device in the third example embodiment;

FIG. 18 illustrates an example of a plan display screen during a sequence process in a fourth example embodiment; and

FIG. 19 illustrates an example of a plan display screen during a sequence process in a fifth example embodiment.

### EXAMPLE EMBODIMENT

Hereinafter, example embodiments of the present disclosure are described in detail with reference to the drawings. In the drawings, the same or corresponding elements are denoted by the same reference signs, and an overlapping description is omitted unless where necessary, for the purpose of clearer description.

### First Example Embodiment

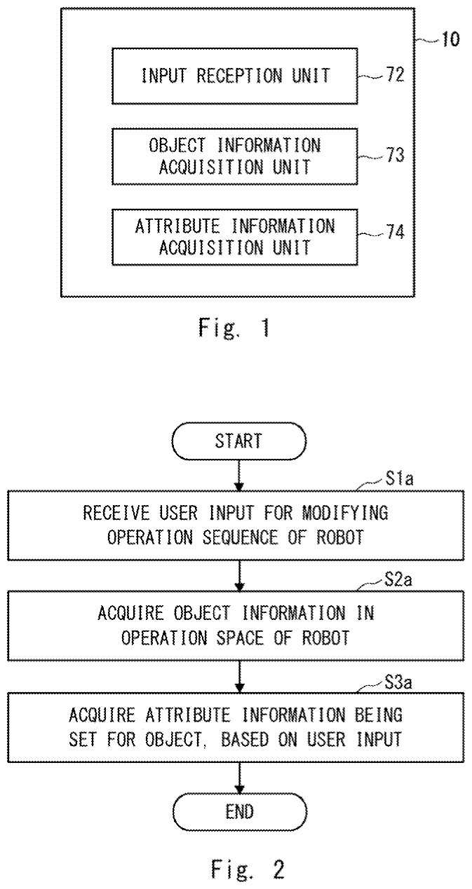

FIG. 1 illustrates a functional block diagram of an information processing device according to a first example embodiment.

An information processing device 10 is implemented by a computer including a processor, a memory, and the like. The information processing device 10 can be used in order to acquire attribute information, when a user modifies an operation sequence for a robot.

The information processing device 10 includes an input reception unit 72, an object information acquisition unit 73 and an attribute information acquisition unit 74. The input reception unit 72 receives an input from a user for modifying an operation sequence for a robot. The input reception unit 72 can receive an input from the user via an input device such as a mouse, a keyboard, a touch panel, a stylus pen, a microphone, or the like.

The object information acquisition unit 73 acquires information relating to an object or a virtual object in an operation space of a robot. In the present specification, the object designates a real object (for example, a real obstacle, a PET bottle, a door). The virtual object designates a virtual object (for example, a virtual obstacle) that is set (for example, depicted) in an operation space of a robot by the user. The object information acquisition unit 73 may acquire object information in the operation space of the robot, based on an input from the user via the input reception unit 72, or may acquire object information in the operation space of the robot, by various sensors such as a camera. For example, the object information acquisition unit 73 can acquire object information (for example, position information, shape, kind of object) in the operation space of the robot, from a photograph image by a camera by utilizing an image recognition technology. In another example embodiment, for example, by the user selecting an object or a virtual object displayed on a display (i.e., via the input reception unit 72 that receives the user input), the object information relating to the object or virtual object can be acquired from a memory unit that stores the information relating to the object or virtual object.

The attribute information acquisition unit 74 acquires attribute information relating to an object, based on an input from the user via the input reception unit 72. The attribute information is an information indicating the attribute of the object, and may be, to be more specific, information that depends on the relationship between the object and the robot. In some example embodiments, when the robot comes in contact with, or cannot pass through, a virtual object depicted by the user, there is a case where an attribute “obstacle” is imparted to the virtual object, and when the robot can pass through the virtual object as a transit point, there is a case where an attribute “transit point” is imparted to the virtual object. In addition, in another example embodiment, when the robot cannot execute a task (for example, “open”) relating to a cap that is an example of an object, there is a case where an attribute “Closed” is imparted to the cap, and, when the robot can execute the task (for example, “open”) relating to the cap, there is a case where an attribute “Open” is imparted to the cap. Furthermore, in another example embodiment, for example, when the robot cannot move an object, there is a case where attribute information “obstacle” is imparted to the object, and, when the robot can move the object, there is a case where attribute information “target object” is imparted to the object. In other words, the attribute information specifies a constraint condition of the robot to the object. Part of the attribute information may include attribute information that cannot exactly be determined even by various sensors such as a camera.

A plurality of selectable pieces of attribute information, which are related to the information relating to the object or virtual object acquired by the object information acquisition unit 73, are presented to the user, and one attribute is acquired by the selection by the user.

The information processing device 10 may include a storage unit that stores various object information and a plurality of selectable pieces of attribute information related to each of objects, or may be connected to such a storage unit via a network.

FIG. 2 is a flowchart illustrating an information processing method according to the first example embodiment.

The input reception unit 72 receives an input from a user for modifying an operation sequence for a robot (step S1a). The object information acquisition unit 73 acquires information of an object or a virtual object in an operation space of the robot (step S2a). The attribute information acquisition unit 74 acquires attribute information relating to the object or virtual object, based on the input from the user (step S3a).

As described above, according to the first example embodiment, when modifying an operation sequence for a robot, an attribute relating to an object in an operation space of the robot can properly be acquired.

### Second Example Embodiment

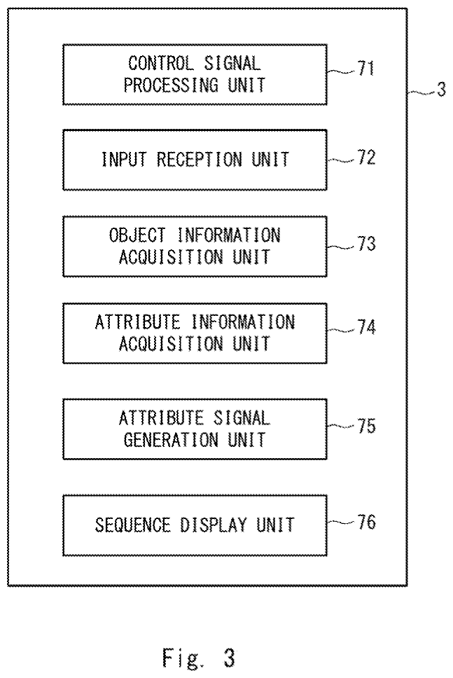

FIG. 3 illustrates a functional block diagram of a modification device 3 according to a second example embodiment. The modification device 3 is implemented by a computer including a processor, a memory, and the like. The modification device 3 can be used in order for the user to modify an operation sequence for a robot, which is displayed. The modification device 3 can be used in cooperation with a robot controller to be described later. As illustrated in FIG. 3, the modification device 3 includes a control signal processing unit 71, an input reception unit 72, an object information acquisition unit 73, an attribute information acquisition unit 74, an attribute signal generation unit 75, and a sequence display unit 76. The modification device 3 is an example of the information processing device 10 according to the first example embodiment.

Upon receiving a control signal from the robot controller, the control signal processing unit 71 generates a signal for displaying a plan of a subtask sequence, and supplies the signal to the sequence display unit 76. In addition, upon receiving a control signal from the robot controller, the control signal processing unit 71 generates an input reception signal for receiving an input from the user, and supplies the input reception signal to the input reception unit 72. Furthermore, upon receiving a signal for operating the robot from the input reception unit 72, the control signal processing unit 71 transmits a control signal indicating a subtask sequence to the robot.

The sequence display unit 76 displays a subtask sequence, based on a control signal received from the robot controller.

The input reception unit 72 receives an input from the user via the input device. The input reception unit 72 accepts, as a user input, an operation necessary for changing a robot operation sequence, such as the depiction of a virtual object in the operation space, the selection of an object or a virtual object, or the change of the attribute of an object or a depicted virtual object.

If the user selects a desired object or virtual object from objects or virtual objects in the displayed operation space by using the input device, the object information acquisition unit 73 acquires object information relating to the object or virtual object. The object information relating to the object or virtual object is stored in advance in the inside of the modification device 3 or in a storage unit connected to the modification device 3.

If the user imparts the attribute relating to the selected object by using the input device, the attribute information acquisition unit 74 acquires the attribute information relating to the object. For example, as described above, if the user selects a desired object or virtual object from objects or virtual objects in the displayed operation space by using the input device, a plurality of attributes related to the desired object or virtual object may be selectively displayed on the display device (for example, a display). Thereafter, if the user selects one attribute from the attributes by using the input device, the attribute information acquisition unit 74 acquires the attribute information.

Based on the above-described object information and attributed information, the attribute signal generation unit 75 generates an attribute signal indicating information in which the acquired information of the object and the acquired information of the attribute are combined, and supplies the attribute signal to the robot controller.

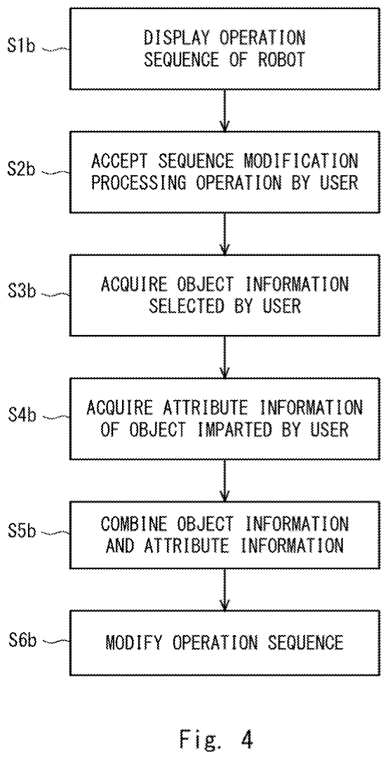

FIG. 4 is a flowchart illustrating a modification method according to the second example embodiment.

Based on the control signal received from the robot controller, the sequence display unit 76 displays an operation sequence (subtask sequence) for the robot (step S1b). The input reception unit 72 receives an input from the user via the input device, in regard to the displayed operation sequence (step S2b). If the user selects a desired object or virtual object from objects or virtual objects in the displayed operation space by using the input device, the object information acquisition unit 73 acquires object information relating to the object or virtual object (step S3b). If the user imparts the attribute relating to the selected object by using the input device, the attribute information acquisition unit 74 acquires the attribute information relating to the object (step S4b). Based on the above-described object information and attributed information, the attribute signal generation unit 75 combines the acquired information of the object and the acquired information of the attribute (step S5b). The attribute signal generation unit 75 generates an attribute signal indicating information in which these pieces of information are combined, and supplies the attribute signal to the robot controller. Thereby, the operation sequence is modified on the robot controller side (step S6b).

According to the above-described second example embodiment, the operation sequence for the robot can be modified, based on the attribute information relating to the object or the like, which is imparted by the user.

### Third Example Embodiment

### (1) System Configuration

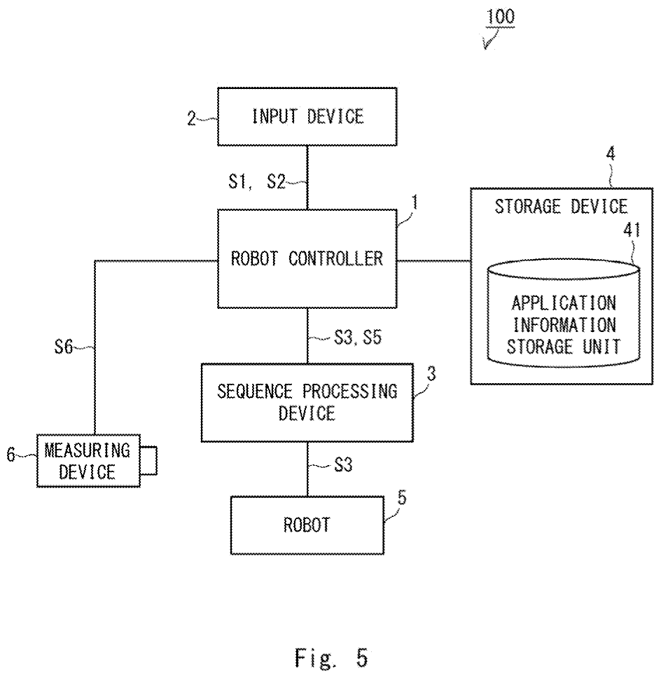

FIG. 5 illustrates a configuration of a robot control system 100 according to a third example embodiment.

The robot control system 100 mainly includes a robot controller 1, an input device 2, a sequence processing device 3, a storage device 4, a robot 5, and a measuring device 6.

When a task to be executed by the robot 5 (also referred to as “target task”) is designated, the robot controller 1 converts the target task to a sequence in units of a time step (time interval) of a simple task that is receivable by the robot 5, and controls the robot 5, based on the sequence. In the present specification, in some cases, the robot controller is referred to as “information processing device”. Hereinafter, a small task (command) receivable by the robot 5, which is a broken-down portion of the target task, is also called “subtask”.

The robot controller 1 is electrically connected to the input device 2, sequence processing device 3, storage device 4, robot 5 and measuring device 6. For example, the robot controller 1 receives an input signal “S1” for designating a target task from the input device 2. In addition, the robot controller 1 transmits to the input device 2 a display signal “S2” for executing display relating to a task to be executed by the robot 5. Further, the robot controller 1 transmits to the robot 5 a control signal “S3” relating to the control of the robot 5. For example, the robot controller 1 transmits, as the control signal S3, a sequence of a subtask (also referred to as “subtask sequence”), which is to be executed by each of robots, to the sequence processing device 3. Moreover, the robot controller 1 receives an output signal “S6” from the measuring device 6. Besides, the robot controller 1 receives, from the sequence processing device 3, an attribute signal “S5” relating to the information of the attribute relating to a specific object or virtual object in the operation space of the robot.

The input device 2 is an interface that receives an input relating to the target task designated by the user, and corresponds to, for example, a touch panel, a button, a keyboard, a sound input device (for example, a microphone), a personal computer, or the like. The input device 2 transmits to the robot controller 1 the input signal S1 that is generate based on the input by the user.

The sequence processing device 3 is a device with a screen on which the user executes an operation necessary for changing a robot operation sequence, such as the display of a subtask sequence, the depiction of a virtual object in the operation space, or the change of the attribute of an object or a depicted virtual object, based on the control signal received from the robot controller 1. The sequence processing device 3 is also called “modification device”, and is an example of the modification device of the second example embodiment. Based on the control signal S3 supplied from the robot controller 1, the sequence processing device 3 executes display of the subtask sequence, and, after displaying the subtask sequence, transmits the control signal S3 to the robot 5. Besides, the sequence processing device 3 transmits to the robot controller 1 an attribute signal S5 representative of the attribute of the object in the operation space of the robot. The input device 2 may be a tablet terminal including an input unit and a display unit, or may be a stationary personal computer.

The storage device 4 includes an application information storage unit 41. The application information storage unit 41 stores application information that is necessary for generating a sequence of a subtask from a target task. The details of the application information will be described later. The storage device 4 may be an external storage medium, such as a hard disk, which is connected to or built in the robot controller 1, or may be a storage medium such as a flash memory. In addition, the storage device 4 may be a server device that executes data communication with the robot controller 1. In this case, the storage device 4 may be composed of a plurality of server devices.

The robot 5 executes an operation relating to the target task, based on the control signal S3 transmitted from the robot controller 1. The robot 5 is, for example, an assembly robot utilized at a manufacturing site, or a robot that performs picking of parcels at a physical distribution site. In the case of a robot arm, the robot arm may include a single arm, or may include two or more arms. Aside from the robot arm, the robot may be a mobile robot, or a robot in which a mobile robot and a robot arm are combined.

The measuring device 6 is one or a plurality of sensors, which can be a camera, a range sensor, a sonar, or a combination thereof, which measures a state of an operation space of a robot. In the present example embodiment, it is assumed that the measuring device 6 includes at least one camera that photographs an operation space. The measuring device 6 supplies a generated measurement signal S6 to the robot controller 1. The measurement signal S6 includes at least image data captured by photographing the inside of the operation space. The measuring device 6 does not need to keep a state at rest, and may be a sensor attached to the robot 5 in motion, a self-advancing mobile robot, or a drone in flight. In addition, the measuring device 6 may include a sensor (for example, a microphone) that detects sound in the operation space. Besides, the measuring device 6 may include a sensor (for example, CCD (charge coupled device) or CMOS (Complementary Metal Oxide Semiconductor) image sensor) that photographs an operation space, the sensor being attached to a freely chosen location including an outside of the operation space.

Note that the configuration of the robot control system 100 illustrated in FIG. 5 is an example, and various modifications may be made to the configuration. For example, a plurality of robots 5 may be present. In addition, the robot 5 may include only one, or two or more control targets, such a plurality of robot arms. In these cases, the robot controller 1 generates, based on the target task, a subtask sequence to be executed for each robot 5, or for each control target included in the robot 5, and transmits the control signal S3 indicating the subtask sequence to the robot 5 including the control target. Besides, the measuring device 6 may be a part of the robot 5. In addition, the input device 2 and the sequence processing device 3 may be treated as an identical device, such as by a mode in which the input device 2 and the sequence processing device 3 are built in the robot controller 1. Furthermore, the robot controller 1 may be composed of a plurality of devices. In this case, the plural devices, which constitute the robot controller 1, execute, among these devices, the transmission and reception of necessary information for executing processes allocated in advance. Additionally, the robot controller 1 and the robot 5 may be constituted as one body. Note that the entirety or a part of the robot control system can be used in order for the user to modify the operation sequence of the robot, and is thus called “modification system” in some cases.

### (2) Hardware Configuration

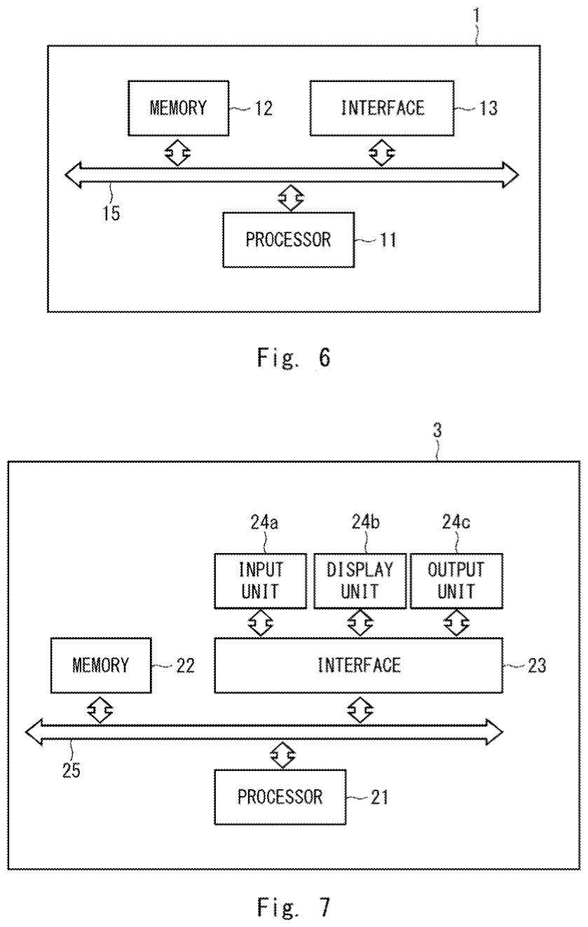

FIG. 6 illustrates a hardware configuration of the robot controller 1. The robot controller 1 includes, as hardware, a processor 11, a memory 12, and an interface 13. The processor 11, memory 12 and interface 13 are connected via a data bus 15.

The processor 11 executes a program stored in the memory 12, thereby functioning as a controller (arithmetic device) that executes overall control of the robot controller 1. The processor 11 is, for example, a processor such as a CPU (Central Processing Unit), a GPU (Graphics Processing Unit) or a TPU (Tensor Processing Unit). The processor 11 may be composed of a plurality of processors.

The memory 12 is composed of various memories such as a RAM (Random Access Memory) and a ROM (Read Only Memory). In addition, the memory 12 stores a program for the robot controller 1 to execute a specific process. In addition, the memory 12 is used as a working memory and temporarily stores information or the like, which is acquired from the storage device 4. Besides, part of the information stored in the memory 12 may be stored in one or a plurality of external storage media that can communicate with the robot controller 1. Furthermore, part of the information may be stored in a storage medium that is detachably attached to the robot controller 1.

The interface 13 is an interface for electrically connecting the robot controller 1 to other devices. Such interfaces may be a wireless interface for transmitting and receiving data to and from other devices by wireless communication, or may be a hardware interface for establishing a wired connection to other devices by using a cable or the like.

Note that the hardware configuration of the robot controller 1 is not limited to the configuration illustrated in FIG. 6. For example, the robot controller 1 may be connected to, or may incorporate, the input device 2, sequence processing device 3, storage device 4 and the sound output device such as a speaker or an earphone. In these cases, the robot controller 1 may be a tablet terminal or the like including an input/output function and a storage function.

FIG. 7 illustrates a hardware configuration of the sequence processing device 3. The sequence processing device 3 includes, as hardware, a processor 21, a memory 22, an interface 23, an input unit 24a, a display unit 24b, and an output unit 24c. The processor 21, memory 22 and interface 23 are connected via a data bus 25. In addition, the input unit 24a, display unit 24b and output unit 24c are connected to the interface 23.

The processor 21 executes a predetermined process by executing a program stored in the memory 22. The processor 21 is, for example, a processor such as a CPU, a GPU or a TPU. Upon receiving a signal generated by the input unit 24a via the interface 23, the processor 21 executes a process of converting the acquired attribute information to an attribute signal S5, and transmits the attribute signal S5 to the robot controller 1 via the interface 23. In addition, based on the control signal S3 received from the robot controller 1 via the interface 23, the processor 21 controls the display unit 24b or the output unit 24c via the interface 23, thus being able to acquire attribute information.

The memory 22 is composed of various memories such as a RAM and a ROM. In addition, the memory 22 stores a program for executing a process that is executed by the sequence processing device. Besides, the memory 22 temporarily stores the control signal S3 received from the robot controller 1.

The interface 23 is an interface for electrically connecting the sequence processing device 3 to other devices. Such interfaces may be a wireless interface for transmitting and receiving data to and from other devices by wireless communication, or may be a hardware interface for establishing a wired connection to other devices by using a cable or the like. In addition, the interface 23 executes interface operations of the input unit 24a, display unit 24b and output unit 24c. The input unit 24a is an interface that receives an input of the user, and corresponds to, for example, a touch panel, a button, a keyboard, a sound input device (for example, a microphone), or the like. The display unit 24b is, for example, a display, a projector, or the like, and executes display, based on the control of the processor 21. Besides, the output unit 24c is, for example, a speaker, and executes sound output, based on the control of the processor 21.

Note that the hardware configuration of the sequence processing device 3 is not limited to the configuration illustrated in FIG. 7. For example, at least one of the input unit 24a, display unit 24b and output unit 24c may be constituted as a separate device that is electrically connected to the sequence processing device 3.

Besides, the sequence processing device 3 may be connected to, or may incorporate, a measuring device such as a camera.

### (3) Application Information

Next, a description is given of a data structure of the application information that the application information storage unit 41 stores.

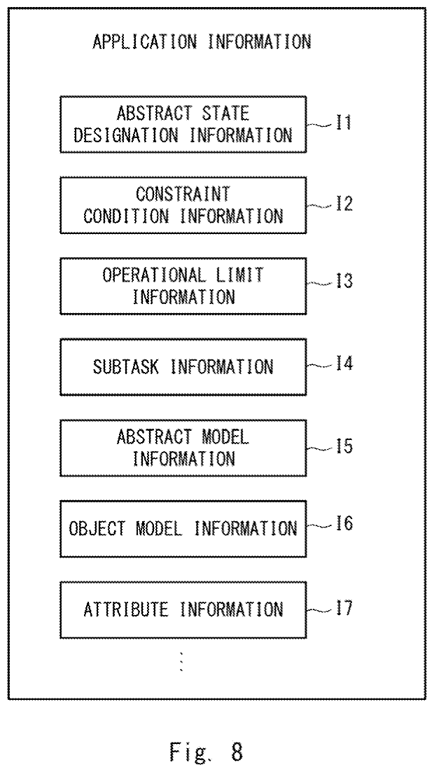

FIG. 8 illustrates an example of the data structure of the application information stored in the application information storage unit 41. As illustrated in FIG. 8, the application information storage unit 41 includes abstract state designation information I1, constraint condition information I2, operational limit information I3, subtask information I4, abstract model information I5, object model information I6, and attribute information I7.

The abstract state designation information I1 is information designating an abstract state that needs to be defined in generating a subtask sequence. The abstract state is an abstract state of an object in the operation space, and is determined as a proposition that is used in a target logical expression to be described later. For example, the abstract state designation information I1 designates an abstract state that needs to be defined, in regard to each of kinds of target tasks. Note that the target task may be, for example, various kinds of tasks, such as pick-and-place, re-holding of a target object, and rotation of a target object.

The constraint condition information I2 is information indicating a constraint condition of executing a target task. For example, when the target task is pick-and-place, the constraint condition information I2 indicates such a constraint condition that the robot 5 (robot arm) must not come in contact with an obstacle, such a constraint condition that the robots 5 (robot arms) must not come in contact with each other, and the like. Note that the constraint condition information I2 may be information recording a constraint condition suited to each of kinds of target tasks.

The operational limit information I3 indicates information relating to an operational limit of the robot 5 that is controlled by the robot controller 1. The operational limit information I3 is, for example, information specifying an upper limit value or a lower limit value of the velocity, acceleration, angular velocity, or the like of the robot 5 illustrated in FIG. 5.

The subtask information I4 indicates information of a subtask that is receivable by the robot 5. For example, when the target task is pick-and-place, the subtask information I4 can specify, as a subtask, reaching that is a movement of the robot arm of the robot 5, and grasping that is a hold by the robot arm. The subtask information I4 may indicate information of a usable subtask in regard to each of kinds of target tasks.

The abstract model information I5 is information relating to an abstract model in which dynamics in the operation space are abstracted. As will be described later, the abstract model is expressed by a model in which real dynamics are abstracted by a hybrid system. The abstract model information I5 includes information indicating a condition for switching of the dynamics in the above-described hybrid system. For example, in the case of the pick-and-place that moves a target object to a predetermined position by the robot 5 by holding the target object by the robot 5, the condition for switching corresponds to such a condition that the target object cannot move unless the target object is grasped by the robot 5. The abstract model information I5 includes information relating to an abstract model suited to each of kinds of target tasks.

The object model information I6 is information relating to an object model of each of objects in the operation space, which is to be recognized from the measurement signal S6 generated by the measuring device 6. The above-described objects correspond, for example, the robot 5, an obstacle, a tool or other target objects handled by the robot 5, a movable body other than the robot 5, and the like. The object model information I6 includes, for example, necessary information for the robot controller 1 to recognize the kind, position and attitude of each of the above-described objects, an operation that is being executed, and the like, and three-dimensional shape information, such as CAD (computer-aided design) data, for recognizing the three-dimensional shape of each object. The former information includes parameters of an inferrer obtained by training a learning model in machine learning such as a neural network. The inferrer is pretrained, for example, such that when an image is input, the inferrer outputs the kind, position, attitude and the like of an object that is a subject in the image.

The attribute information I7 is information indicating an attribute of an object or a virtual object (for example, an immovable obstacle or a movable target object), and is information for adding an internal process in the robot controller 1. Specifically, the attribute information I7 depends on the relationship between the object or virtual object and the robot, and is a constraint condition of the robot in regard to the object or virtual object. Upon receiving the attribute signal S5 generated by the sequence process device 3, the robot controller 1 can execute an internal process in accordance with the acquired attribute. For example, when a virtual obstacle is newly generated, the sequence processing device 3 executes a process of updating the information of the value of a position vector of an obstacle depicted by the user, and the number of obstacles after the depiction, thereby being able to execute robot control in a new operation space in which an obstacle is newly disposed in the operation space. In another example of changing an object in the operation space of the robot from an obstacle to a target object, a process is executed to change an identification label in the object model information I6 from an immovable obstacle to a movable target object, and thereby an object that has been an obstacle is regarded as a target object, and an operation, such as pick-and-place, of the object regarded as the target object can be executed.

The above-described attribute information (obstacle or target object) is information indicating whether the robot can move an object. In other words, the attribute information is based on the relationship between the robot and the object. In another example embodiment, as will be described later, various attributes can be used.

In this manner, various attribute information I7 is set in advance, and stored in the application information storage unit 41.

Note that the application information storage unit 41 may store, in addition to the above-described information, various information relating to a subtask sequence generation process and the control signal S3.

### (4) Functional Block Diagram

### (4-1) Functional Block Diagram of the Robot Controller

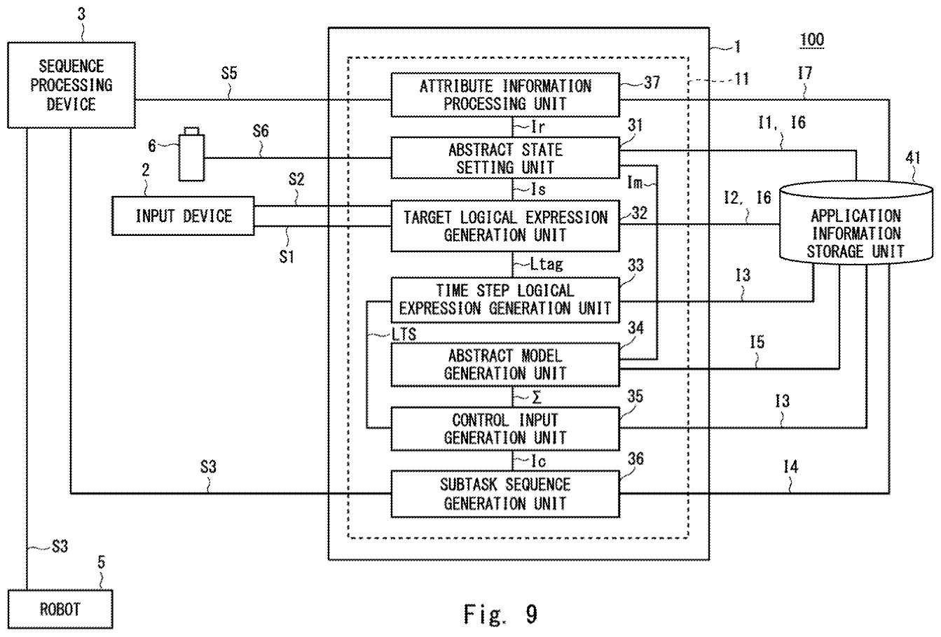

FIG. 9 illustrates an example of a functional block diagram of the robot controller 1. The processor 11 of the robot controller 1 includes, in terms of functions, an abstract state setting unit 31, a target logical expression generation unit 32, a time step logical expression generation unit 33, an abstract model generation unit 34, a control input generation unit 35, a subtask sequence generation unit 36, and an attribute information processing unit 37. Note that although FIG. 8 illustrates an example of data transmitted and received between blocks, the data is not limited to this example. The same applies to other functional block diagrams to be described later.

The abstract state setting unit 31 generates information indicating a measurement result (also referred to as “measurement information Im”) in the operation space, based on the output signal S6 supplied from the measuring device 6. Specifically, upon receiving the output signal S6, the abstract state setting unit 31 refers to the object model information I6 and the like, recognizes the kind (the robot 5, obstacle, tool or other target objects handled by the robot 5, a movable body other than the robot 5) and the position of each object in the operation space relating to the execution of the target task, and generates the recognition result as the measurement information Im. In addition, upon receiving a signal supplied from the attribute information processing unit 37, the abstract state setting unit 31 updates the above-described measurement information Im, and newly generates information indicating a measurement result in the operation space, in which the attribute is taken into account. The abstract state setting unit 31 supplies the generated measurement information Im to the abstract model generation unit 34.

In addition, the abstract state setting unit 31 sets an abstract state in the operation space of executing the target task, based on the above-described measurement information Im and the abstract state designation information I1 acquired from the application information storage unit 41. In this case, the abstract state setting unit 31 defines a proposition for the representation by a logical expression in regard to each abstract state. The abstract state setting unit 31 supplies the information indicating the set abstract state (also referred to as “abstract state setting information Is”) to the target logical expression generation unit 32.

Upon receiving the input signal S1 relating to the target task from the input device 2, the target logical expression generation unit 32 converts, based on the abstract state setting information Is, the target task indicated by the input signal S1 to a logical expression (also referred to as “target logical expression Ltag”) of a time-phase logic representing a finally achieved state. In this case, by referring to the constraint condition information I2 from the application information storage unit 41, the target logical expression generation unit 32 adds to the target logical expression Ltag a constraint condition that is to be satisfied in the execution of the target task. Further, the target logical expression generation unit 32 supplies the generated target logical expression Ltag to the time step logical expression generation unit 33. Besides, the target logical expression generation unit 32 generates a display signal S2 for displaying a task input screen that receives a necessary input for the execution of the target task, and supplies the display signal S2 to the input device 2.

The time step logical expression generation unit 33 converts the target logical expression Ltag, which is supplied from the target logical expression generation unit 32, to a logical expression (also referred to as “time step logical expression Lts”) representative of a state at each time step. In addition, the time step logical expression generation unit 33 supplies the generated time step logical expression Lts to the control input generation unit 35.

The abstract model generation unit 34 generates a model in which real dynamics in the operation space are abstracted, based on the measurement information Im and the abstract model information I5 stored in the application information storage unit 41.

Note that the abstract model is indicated by the following.
Σ

In this case, the abstract model generation unit 34 regards the dynamics of the target as a hybrid system in which continuous dynamics and discrete dynamics are mixed, and generates an abstract model based on the hybrid system. A generation method of an abstract model will be described later. The abstract model generation unit 34 supplies the generated abstract model to the control input generation unit 35.

The control input generation unit 35 determines a control input to the robot 5 for each time step, which satisfies the time step logical expression Lts supplied from the time step logical expression generation unit 33 and the abstract model supplied from the abstract model generation unit 34, and which optimizes an evaluation function. In addition, the control input generation unit 35 supplies information (also referred to as “control input information Ic”) indicating the control input to the robot 5 for each time step to the subtask sequence generation unit 36.

The subtask sequence generation unit 36 generates a subtask sequence, based on the control input information Ic supplied from the control input generation unit 35 and the subtask information I4 stored in the application information storage unit 41, and supplies a control signal S3 indicating the subtask sequence to the sequence processing unit 3.

Based on the attribute signal S5 supplied from the sequence processing device 3 and the attribute information I7 stored in the application information storage unit 41, the attribute information processing unit 37 generates modification information Ir for modifying the above-described abstract state, in accordance with a combination of the information of a specific object or virtual object and a specific attribute. The attribute information processing unit 37 supplies the modification information Ir to the abstract state setting unit 31.

### (4-2) Functional Block Diagram of the Sequence Processing Device

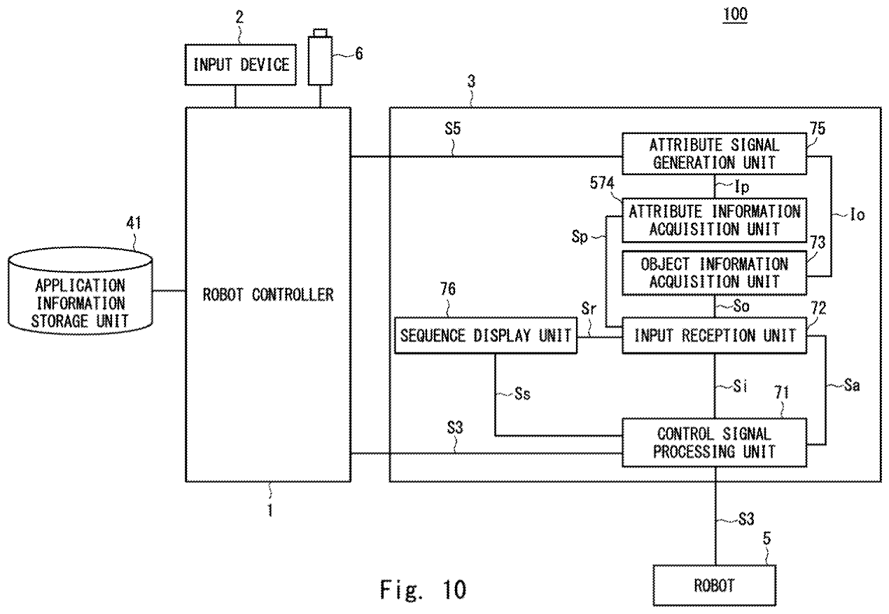

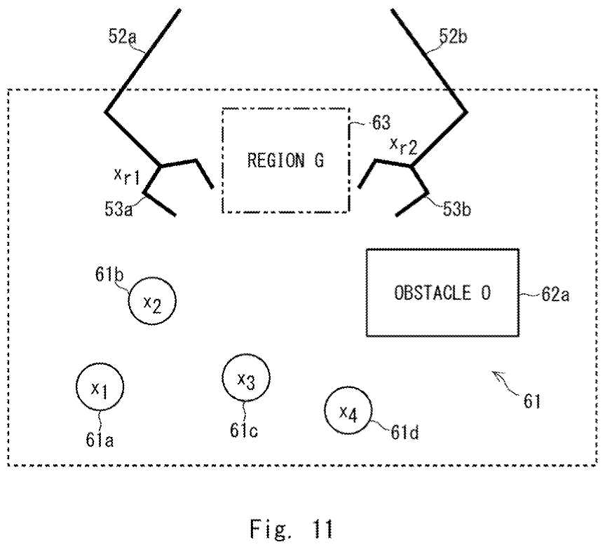

FIG. 10 is an example of a functional block diagram of the sequence processing device 3. The processor 11 of the sequence processing device 3 includes, in terms of functions, a control signal processing unit 71, an input reception unit 72, an object information acquisition unit 73, an attribute information acquisition unit 74, an attribute signal generation unit 75, and a sequence display unit 76. Note that although FIG. 10 illustrates an example of data transmitted and received between blocks, the data is not limited to this example. The same applies to other functional block diagrams to be described later.

Upon receiving the control signal S3 from the robot controller 1, the control signal processing unit 71 generates a signal Ss for displaying a plan of a subtask sequence, and supplies the signal Ss to the sequence display unit 76. In addition, upon receiving the control signal from the robot controller 1, the control signal processing unit 71 generates an input reception signal Si for receiving an input from the user, and supplies the input reception signal S1 to the input reception unit 72. Furthermore, upon receiving a signal Sa for operating the robot 5 from the input reception unit 72, the control signal processing unit 71 transmits the control signal S3 indicating the subtask sequence to the robot 5.

The input reception unit 72, when supplied with an input reception signal Si from the control signal processing unit 71, enables an operation by the user on the screen. In addition, the input reception unit 72 generates an input display signal Sr for displaying content, which is input by the user, on the screen in real time, and transmits the input display signal Sr to the sequence display unit 76. Further, when the user executes an operation of selecting an object or virtual object on the screen, the input reception unit 72 generates an object selection signal So indicating that the object or virtual object has been selected on the screen, and supplies the object selection signal So to the object information acquisition unit 73. Moreover, when the user executes an operation of selecting an attribute on the screen, the input reception unit 72 generates an attribute selection signal Sp indicating that the attribute has been selected on the screen, and supplies the attribute selection signal Sp to the attribute information acquisition unit 74. Besides, the input reception unit 72 generates a signal Sa for operating the robot 5, and supplies the signal Sa to the control signal processing unit 71.

The object information acquisition unit 73, when supplied with the object selection signal So from the input reception unit 72, acquires object selection information Io representative of information (for example, position vector, kind of object) of an object corresponding to the object selection signal So, and supplies the object selection information Io to the attribute signal generation unit 75. For example, of the information of the object, a position vector can be measured by the measuring device 6. For example, of the information of the object, the kind of object can be acquired by recognizing the photograph image by the measuring device 6 by an image recognition technology. The information of a virtual object depicted by the user can be acquired from the storage unit that stores drawing information.

The attribute information acquisition unit 74, when supplied with the object selection signal So from the input reception unit 72, acquires attribute selection information Ip corresponding to the object selection signal So, and supplies the attribute selection information Ip to the attribute signal generation unit 75. As will be described later, the attribute selection information corresponds to various objects, and is stored in the storage unit as a plurality of selectable pieces of attribute information.

Based on the object selection information Io and the attribute selection information Ip, the attribute signal generation unit 75 generates an attribute signal S5 indicating the information in which the acquired information of the object and the acquired information of the attribute are combined. By being supplied to the attribute information processing unit 37 of the robot controller 1, the attribute signal S5 can notify the robot controller 1 of the information indicating that “a specific attribute is imparted to the specific object or virtual object selected by the user.”

(5) Details of the Process of Each Block of the Robot Controller Next, using concrete examples, a description is given of the details of the process of each functional block of the robot controller 1 illustrated in FIG. 9.

### (5-1) Abstract State Setting Unit

The abstract state setting unit 31 refers to the object model information I6, analyzes the output signal S6 supplied from the measuring device 6, based on a technology of recognizing the operation space, and generates the measurement information Im indicating the measurement result (kind, position, and the like) of each object in the operation space. Further, the abstract state setting unit 31 sets the abstract state in the operation space, as well as generating the measurement information Im. In this case, the abstract state setting unit 31 refers to the abstract state designation information I1, and recognizes the abstract state that is to be set in the operation space. Note that the abstract state that is to be set in the operation space varies depending on the kind of target task. Thus, when the abstract state to be set is specified in the abstract state designation information I1 in regard to each of kinds of target tasks, the abstract state setting unit 31 refers to the abstract state designation information I1 corresponding to the target task designated by the input signal S1, and recognizes the abstract state that is to be set.

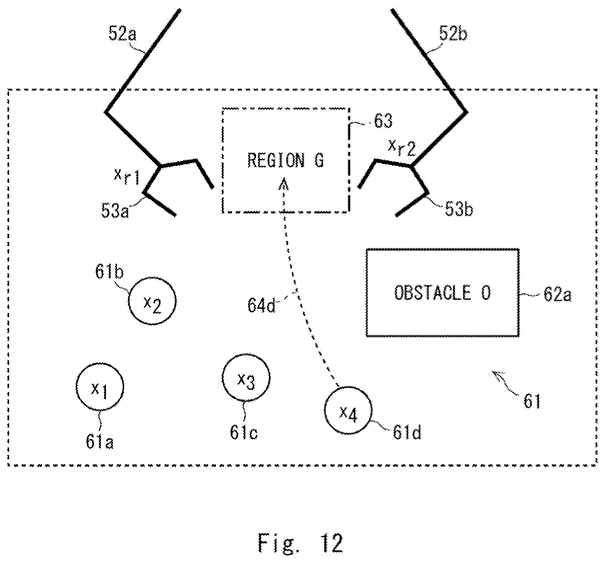

FIG. 11 illustrates an example of a bird's-eye view of the operation space in a case where pick-and-place is set as the target task. In the operation space illustrated in FIG. 11, there exist two robot arms 52a and 52b, four objects 61a to 61d, and an obstacle 62a.

In this case, to begin with, the abstract state setting unit 31 of the robot controller 1 analyzes the output signal S6 received from the measuring device 6, by using the object model information I6 or the like, thereby recognizing the state of the object 61, an existence range of the obstacle 62a, and an existence range of a region G that is set as a goal point. Here, the abstract state setting unit 31 recognizes position vectors “x₁” to “x₄” of the centers of the objects 61a to 61d as positions of the objects 61a to 61d. In addition, the abstract state setting unit 31 recognizes a position vector “xᵣ₁” of the robot hand 53a that grasps the object 61, and a position vector “xᵣ₂” of the robot hand 53b, as positions of the robot arm 52a and the robot arm 52b. Similarly, the abstract state setting unit 31 recognizes attitudes (not necessary in the example of FIG. 11 since the objects are spherical) or the like of the objects 61a to 61d, the existence range of the obstacle 62a, the existence range of the region G, and the like. Note that, for example, when the obstacle 62a is regarded as a rectangular parallelepiped and the region G is regarded as a rectangle, the abstract state setting unit 31 recognizes position vectors of the vertices of the obstacle 62a and the region G. Furthermore, the abstract state setting unit 31 generates, as the measurement information Im, the recognition results based on the output signal S6.

In addition, the abstract state setting unit 31 determines the abstract state to be defined in the target task, by referring to the abstract state designation information I1. In this case, the abstract state setting unit 31 recognizes, based on the measurement information Im, the objects and region existing in the operation space, and determines the proposition indicating the abstract state, based on the recognition result (for example, the numbers of objects and regions in regard to each of kinds) relating to the objects and region, and the constraint condition information I2.

In the example of FIG. 11, the abstract state setting unit 31 imparts identification labels “1” to “4” to the objects 61a to 61d that are specified by the measurement information Im. In addition, the abstract state setting unit 31 defines a proposition “gᵢ” that an object “i” (i=1˜4) exists in the region G (see a broken-line box 63) that is a target point where the object “i” is to be finally placed. Further, the abstract state setting unit 31 imparts an identification label “O” to the obstacle 62 specified by the measurement information Im, and defines a proposition “oᵢ” that the object i interferes with the obstacle O. Moreover, the abstract state setting unit 31 defines a proposition “h” that the robot arms 52 interfere with each other.

FIG. 14 illustrates a bird's-eye view of an operation space after being modified by the sequence processing device 3. In the operation space illustrated in FIG. 9, there exist two robot arms 52a and 52b, four objects 61a to 61d, an obstacle 62a, and a virtual obstacle 62b. The difference from FIG. 11 is the presence/absence of the virtual obstacle 62b, and the virtual obstacle 62b illustrated in FIG. 14 is a virtual obstacle depicted by the user when the modification information Ir for modifying the abstract state is generated by the attribute information processing unit 37 in the robot controller 1. In this case, the abstract state setting unit 31, if supplied with the modification information Ir, regards the substance of the virtual obstacle 62b as being actually present in the operation space, and executes re-recognition such that the virtual obstacle 62b is newly disposed in the operation space.

In this case, in addition to the recognition in the operation space before the modification, the abstract state setting unit 31 recognizes the existence range of the virtual obstacle 62b by being supplied with the modification information Ir that is generated by the attribute information processing unit and that reflects the attribute of the virtual obstacle 62b. In addition, the abstract state setting unit 31 generates, as the measurement information Im, the recognition results based on the output signal S6 and the modification information Ir.

In the example of FIG. 14, the abstract state setting unit 31 imparts identification labels “1” to “4” to the objects 61a to 61d that are specified by the measurement information Im. In addition, the abstract state setting unit 31 defines a proposition “gᵢ” that an object “i” (i=1˜4) exists in the region G (see a broken-line box 63) that is the target point where the object “i” is to be finally placed. Further, the abstract state setting unit 31 imparts an identification label “O” to the obstacle 62a specified by the measurement information Im, and defines a proposition “oᵢ” that the object i interferes with the obstacle O. Besides, the abstract state setting unit 31 imparts an identification label “Ov” to the virtual obstacle 62b specified by the modification information Ir, and defines a proposition “ovᵢ” that the object i interferes with the virtual obstacle Ov. Moreover, the abstract state setting unit 31 defines a proposition “h” that the robot arms 52 interfere with each other.

In this manner, the abstract state setting unit 31 recognizes the abstract state to be defined, by referring to the abstract state designation information Ti, and defines the propositions (gᵢ, oᵢ, ovᵢ, h in the above example) representative of the abstract state, in accordance with the number of objects 61, the number of robot arms 52, the number of obstacles 62, and the like. Furthermore, the abstract state setting unit 31 supplies the information indicating the propositions representing the abstract state to the target logical expression generation unit 32 as the abstract state setting information Is.

### (5-2) Target Logical Expression Generation Unit

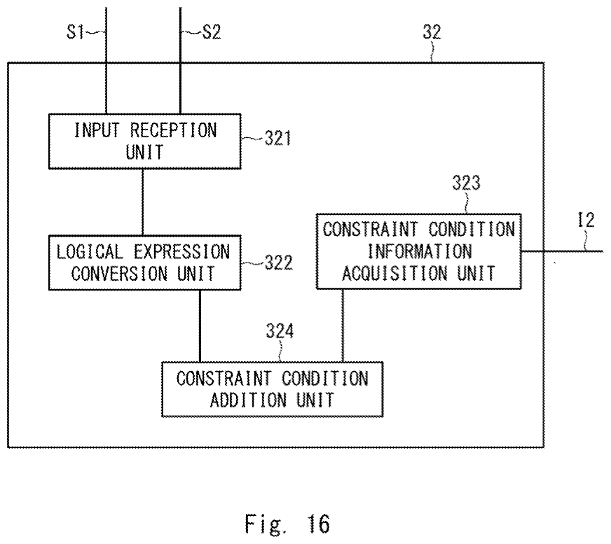

FIG. 16 is a functional block configuration diagram of the target logical expression generation unit 32. As illustrated in FIG. 16, the target logical expression generation unit 32 includes, in terms of functions, an input reception unit 321, a logical expression conversion unit 322, a constraint condition information acquisition unit 323, and a constraint condition addition unit 324.

The input reception unit 321 receives the input of the input signal S1 designating the kind of target task and the final state of a target object that is a work target of the robot. In addition, the input reception unit 321 transmits the display signal S2 of the task input screen, which receives these inputs, to the target logical expression generation unit 32 of the robot controller 1.

The logical expression conversion unit 322 converts the target task designated by the input signal S1 to a logical expression using a time-phase logic. Note that there are various technologies for the method of converting a task expressed by a natural language into a logical expression. For example, in the example of FIG. 11, it is assumed that a task “the target object (i=2) finally exists in the region G” is given. In this case, the target logical expression generation unit 32 converts the target task and generates a logical expression “⋄g₂” by using an operator “⋄” corresponding to “eventually” of a linear logical expression (LTL: Linear Temporary Logic) and a proposition “gᵢ” defined by the abstract state setting unit 31. Besides, the target logical expression generation unit 32 may express a logical expression by using operators of an arbitrary time-phase logic (logical product “∧”, logical sum “∨”, negation “¬”, logical implication “=>”, always “□”, next “◯”, until “U”, etc.) other than the operator “⋄”. In addition, aside from the linear time-phase logic, a logical expression may be expressed by using an arbitrary time-phase logic such as MTL (Metric Temporal Logic) or STL (Signal Temporal Logic).

The constraint condition information acquisition unit 323 acquires the constraint condition information I2 from the application information storage unit 41. Note that if the constraint condition information I2 is stored in the application information storage unit 41 in regard to each of kinds of tasks, the constraint condition information acquisition unit 323 acquires the constraint condition information I2, which corresponds to the kind of the target task designated by the input signal S1, from the application information storage unit 41.

The constraint condition addition unit 324 adds the constraint condition, which is indicated by the constraint condition information I2 acquired by the constraint condition information acquisition unit 323, to the logical expression generated by the logical expression conversion unit 322, thereby generating the target logical expression Ltag.

For example, when two constraint conditions, “robot arms 52 do not interfere with each other” and “object i does not interfere with the obstacle O”, are included in the constraint condition information I2 as the constraint conditions corresponding to pick-and-place, the constraint condition addition unit 324 converts the constraint conditions to logical expressions. Specifically, the constraint condition addition unit 324 converts the above two constraint conditions to the following logical expressions by using the proposition “oᵢ” and proposition “h” defined by the abstract state setting unit 31 in the above description.

□¬h

∧ᵢ□¬oᵢ

Thus, in this case, the constraint condition addition unit 324 generates the following target logical expression Ltag, by adding the logical expressions of these constraint conditions to the logical expression “⋄g₂” corresponding to the target task “the target object (i=2) finally exists in the region G”.

(⋄g₂)∧(□¬h)∧(∧ᵢ□¬oᵢ)

Note that, actually, aside from the above two constraint conditions, there are such constraint conditions corresponding to pick-and-place as “the robot arms 52 do not grasp an identical target object” and “target objects do not come in contact with each other”. Besides, the constraint conditions in the operation space after modification as illustrated in FIG. 14 include such a constraint condition as “the object i does not interfere with the virtual obstacle Ov”. Such constraint conditions are similarly stored in the constraint condition information I2 and are reflected in the target logical expression Ltag.

### (5-3) Time Step Logical Expression Generation Unit

The time step logical expression generation unit 33 determines the number of time steps (also referred to as “target time step number”) for completing the target task, and determines such a combination of propositions representing the states in the respective time steps as to satisfy the target logical expression Ltag by the target time step number. Usually, since a plurality of combinations exist, the time step logical expression generation unit 33 generates, as a time step logical expression Lts, a logical expression in which these combinations are combined by a logical sum. The above combinations are candidates of the logical expression representing the operation sequence for instructing the robot 5, and are hereinafter referred to as “candidates (p”.

Here, a description is given of a concrete example of the process of the time step logical expression generation unit 33 (FIG. 9) in a case where the target task “the target object (i=2) finally exists in the region G” exemplified in the description of FIG. 11 is set.

In this case, the time step logical expression generation unit 33 is supplied with “(⋄g₂)∧(o¬h)∧(∧ᵢ□¬oᵢ)” from the target logical expression generation unit 32 as the target logical expression Ltag. In this case, the time step logical expression generation unit 33 uses a proposition “g_{i,k}” in which the proposition “gᵢ” is extended so as to include the concept of the time step. Here, the proposition “g_{i,k}” is a proposition “the object i exists in the region G in time step k”. Here, when the target time step number is set at “3”, the target logical expression Ltag is rewritten as follows.

(⋄g_{2,3})∧(∧_{k=1,2,3}□¬hₖ)∧(∧_{i,k=1,2,3}□¬oᵢ)

In addition, ⋄g_{2,3} can be rewritten as indicated by the following equation.

[symbol]

g_{2,3}=(¬g_{2,1}∧¬g_{2,2}∧g_{2,3})∨(¬g_{2,1}∧g_{2,2}∧g_{2,3})∨(g_{2,1}∧¬g_{2,2}∧g_{2,3})∨(g_{2,1}∧g_{2,2}∧g_{2,3}) [Math. 1]

At this time, the above-described target logical expression Ltag is expressed by a logical sum (φ₁∨φ₂∧φ₃∨φ₄) of the following four candidates “φ₁” to “φ₄”.

ϕ₁=(¬g_{2,1}∧¬g_{2,2}∧g_{2,3})∧(∧_{k=1,2,3}□¬hₖ)∧(∧_{i,k=1,2,3}□¬o_{i,k})

ϕ₂=(¬g_{2,1}∧g_{2,2}∧g_{2,3})∧(∧_{k=1,2,3}□¬hₖ)∧(∧_{i,k=1,2,3}□¬o_{i,k})

ϕ₃=(g_{2,1}∧¬g_{2,2}∧g_{2,3})∧(∧_{k=1,2,3}□¬hₖ)∧(∧_{i,k=1,2,3}□¬o_{i,k})

ϕ₄=(g_{2,1}∧g_{2,2}∧g_{2,3})∧(∧_{k=1,2,3}□¬hₖ)∧(∧_{i,k=1,2,3}□¬o_{i,k}) [Math. 2]

Thus, the time step logical expression generation unit 33 determines the logical sum of the four candidates φ₁ to φ₄ as the time step logical expression Lts. In this case, the time step logical expression Lts becomes true when at least any one of the four candidates φ₁ to φ₄ becomes true.

Preferably, by referring to the operational limit information I3 in regard to the generated candidate, the time step logical expression generation unit 33 may determine feasibility and may exclude a candidate that is determined to be unfeasible. For example, based on the operational limit information I3, the time step logical expression generation unit 33 recognizes a distance over which the robot hand can move per time step. Besides, based on the position vectors of each target object and the robot hand indicated by the measurement information Im, the time step logical expression generation unit 33 recognizes a distance between the target object (i=2) that is a target of movement and the robot hand.

For example, when determining that the distance between each of the robot hand 53a and robot hand 53b and the target object (i=2) is greater than the movable distance per time step, the time step logical expression generation unit 33 determines that the above-described candidate φ₃ and candidate φ₄ are unfeasible. In this case, the time step logical expression generation unit 33 excludes the candidate φ₃ and candidate φ₄ from the time step logical expression Lts. In this case, the time step logical expression Lts becomes a logical sum (φ₁∧φ₂) of the candidate φ₁ and candidate φ₂.

In this manner, the time step logical expression generation unit 33 can preferably reduce the processing load of a rear-stage processing unit, by referring to the operational limit information I3 and excluding unfeasible candidates from the time step logical expression Lts.

Next, the method of setting the target time step number is supplementally described.

For example, based on an estimated time of a work designated by a user input, the time step logical expression generation unit 33 determines the target time step number. In this case, the time step logical expression generation unit 33 calculates the target time step number from the above-described estimated time, based on the information of a time width per time step, which is stored in the memory 12 or storage device 4. In another example, the time step logical expression generation unit 33 prestores in the memory 12 or storage device 4 the information in which an appropriate target time step number is correlated with each of kinds of target tasks, and determines the target time step number corresponding to the kind of the target task to be executed, by referring to this information.

Preferably, the time step logical expression generation unit 33 sets the target time step number at a predetermined initial value. Then, the time step logical expression generation unit 33 gradually increases the target time step number until the time step logical expression Lts, by which the control input generation unit 35 can determine the control input, is generated. In this case, the time step logical expression generation unit 33 increments the target time step number by a predetermined number (an integer of 1 or more), when an optimal solution cannot be derived as a result of the execution of an optimizing process by the control input generation unit 35 by the set target time step number.

At this time, it is preferably that the time step logical expression generation unit 33 sets the initial value of the target time step number to a value less than the time step number corresponding to the work time of the target task estimated by the user. Thereby, the time step logical expression generation unit 33 preferably prevents the setting of an unnecessarily large target time step number.

The advantageous effects by the above-described setting method of the target time step number are supplementarily described. In general, as the target time step number becomes greater, the possibility of the presence of an optimal solution increases in the optimizing process by the control input generation unit 35, while the processing load of a minimizing process or the like and the needed time of the robot 5 for achieving the target task increase. Taking the above into account, the time step logical expression generation unit 33 sets the initial value of the target time step number to a small value, and gradually increases the target time step number until a solution in the optimizing process of the control input generation unit 35 comes into existence. Thereby, the time step logical expression generation unit 33 can set a smallest possible target time step number within the range in which the solution in the optimizing process of the control input generation unit 35 exists. Accordingly, in this case, it is possible to achieve a decrease in processing load in the optimizing process, and a decrease in the needed time of the robot 5 for achieving the target task.

### (5-4) Abstract Model Generation Unit

The abstract model generation unit 34 generates an abstract model, based on the measurement information Im and the abstract model information I5. Here, in the abstract model information I5, the necessary information for generating the abstract model is recorded in regard to each of the kinds of target tasks. For example, when the target task is pick-and-place, an abstract model of a general-purpose format, which does not specify the positions or number of target objects, the position of a region where a target object is placed, the number of robots 5 (or the number of robot arms 52) or the like, is recorded in the abstract model information I5. In addition, the abstract model generation unit 34 generates an abstract model Σ by reflecting the positions or number of target objects, the position of a region where a target object is placed, the number of robots 5, or the like, which are indicated by the measurement information Im, onto the abstract model of the general-purpose format recorded in the abstract model information I5.

Here, at the work time of the target task by the robot 5, the dynamics in the operation space change frequently. For example, in the pick-and-place, when the robot arm 52 grasps the object i, the object i moves, but when the robot arm 52 does not grasp the object i, the object i does not move.

Taking the above into account, in the present example embodiment, in the case of the pick-and-place, the operation of grasping the object i is abstractly expressed by a logical variable “δᵢ”. In this case, for example, the abstract model generation unit 34 can determine an abstract model that is to be set for the operation space illustrated in FIG. 1, by the following equation (1).

$$[ Math . 3 ]$$

$${[ \begin{matrix}{x}_{r 1} \\ {x}_{r 2} \\ {x}_{1} \\ ⋮ \\ {x}_{4}\end{matrix} ]}_{k + 1} = {I [ \begin{matrix}{x}_{r 1} \\ {x}_{r 2} \\ {x}_{1} \\ ⋮ \\ {x}_{4}\end{matrix} ]}_{k} + [ \begin{matrix}I & 0 \\ 0 & I \\ {δ}_{1 , 1} I & {δ}_{2 , 1} I \\ ⋮ & ⋮ \\ {δ}_{1 , 4} I & {δ}_{2 , 4} I\end{matrix} ] [ \begin{matrix}{u}_{1} \\ {u}_{2}\end{matrix} ] \\ {h}_{{ij}_{min}} ( 1 - {δ}_{i} ) \leq {h}_{ij} ( x ) \leq {h}_{{ij}_{max}} {δ}_{i} + ( {δ}_{i} - 1 ) ε \qquad ( 1 )$$

Here, “uⱼ” indicates a control input for controlling a robot hand j (“j=1” is the robot hand 53a, and “j=2” is the robot hand 53b), and “I” indicates a identity matrix. Note that, here, by way of example, a velocity is assumed as the control input, but the control input may be an acceleration. In addition, “δ_{j,i}” is a logical variable that becomes “1” in a case where the robot hand j grasps the object i, and becomes “0” in other cases. Further, “xᵣ₁” and “xᵣ₂” indicate position vectors of the robot hand j, and “x₁” to “x₄” indicate position vectors of the object i. Besides, “h(x)” is a variable that becomes “h(x)≥0” when the robot hand exists so near a target object that the robot hand can grasp the target object, and meets the following relationship with the logical variable δ.

δ=1<=>h(x)≥0

Here, equation (1) is a difference equation indicating the relationship between the state of the object in a time step k and the state of the object in a time step k+1. In addition, in the above equation (1), since the state of grasping is expressed by a logical variable that is a discrete value and the movement of the object is expressed by a continuous value, equation (1) indicates a hybrid system.

Equation (1) takes into account, not the detailed dynamics of the entirety of the robot 5, but only the dynamics of the robot hand that is a tip portion of the robot 5, which actually grasps the target object. Thereby, the calculation amount of the optimizing process can preferably be reduced by the control input generation unit 35.

In addition, the abstract model information I5 records the information for deriving the difference equation of equation (1) from the logical variable corresponding to an operation in which dynamics are changed (an operation of grasping the object i in the case of pick-and-place) and the measurement information Im. Thus, even in the case where the positions or number of target objects, the position of a region where a target object is placed (region G in FIG. 11), the number of robots 5, or the like changes, the abstract model generation unit 34 can determine the abstract model conforming to the environment of the operation space of the target, by combining the abstract model information I5 and the measurement information Im.

Instead of the model indicated in equation (1), the abstract model generation unit 34 may generate a model of a mixed logical dynamical (MLD) system or a hybrid system combined with a Petri net, an automaton, or the like.

### (5-5) Control Input Generation Unit

Based on the time step logical expression Lts supplied from the time step logical expression generation unit 33 and the abstract model supplied from the abstract model generation unit 34, the control input generation unit 35 determines a control input in each time step for the robot 5 in each optimal time step. In this case, the control input generation unit 35 defines an evaluation function for the target task, and solves an optimization problem for minimizing the evaluation function, by setting the abstract model and the time step logical expression Lts as constraint conditions. For example, the evaluation function is preset for each of kinds of target tasks, and stored in the memory 12 or storage device 4.

For example, when pick-and-place is the target task, the control input generation unit 35 determines the evaluation function such that a distance “dₖ” between a target object that is an object of carrying and a target point to which the object is carried, and a control input “uₖ”, become minimum (i.e., such that the energy consumed by the robot 5 is minimized). The above-described distance “dₖ” corresponds to a distance between the target object (i=2) and the region G, in the case of the target task of “the target object (i=2) finally exists in the region G”.

For example, the control input generation unit 35 determines, as the evaluation function, the sum of a square of the distance dₖ in all time steps and a square of the control input uₖ, and solves a constrained mixed integer optimization problem indicated in the following expression (2), in which the abstract model and the time step logical expression Lts (i.e., a logical sum of candidate φᵢ) are set as constraint conditions.

$$[ Math . 4 ]$$

$${min}_{u} ( {\sum }_{k = 0}^{T} ( {‖ {d}_{k} ‖}_{2}^{2} ) + ( {‖ {u}_{k} ‖}_{2}^{2} ) ) \\ s . t . \sum \\ ∨ {ϕ}_{i} \qquad ( 2 )$$

Here, “T” is a time step number that is a target of optimization, and may be a target time step number, or may be a predetermined number less than the target time step number, as will be described later. In this case, preferably, the control input generation unit 35 approximates the logical variable to a continuous value (solving a continuous relaxation problem). Thereby, the control input generation unit 35 can preferably reduce the calculation amount. Note that when STL is adopted in place of the linear logical expression (LTL), a description as a nonlinear optimization problem is possible.

Besides, when the target time step number is long (for example, longer than a predetermined threshold), the control input generation unit 35 may set the time step number for use in optimization to a value (for example, the above-described threshold) that is less than the target time step number. In this case, the control input generation unit 35 successively determines the control input uₖ, for example, by solving the above-described optimization problem each time a predetermined time step number has elapsed.

Preferably, the control input generation unit 35 may solve the above-described optimization problem at each predetermined event corresponding to an intermediate state in regard to an achievement state of the target task, and may determine the control input uₖ to be used. In this case, the control input generation unit 35 sets a time step number until the occurrence of the next event to a time step number that is used for optimization. The above-described event is, for example, an event in which the dynamics in the operation space are changed. For example, when pick-and-place is set as the target task, that the robot 5 grasps the target object, or that one of target objects to be carried by the robot 5 is completely carried to a target point, or the like, is set as the event. The event is, for example, preset for each of kinds of target tasks, and the information specifying the event for each of kinds of target tasks is stored in the memory device 4.

### (5-6) Subtask Sequence Generation Unit

The subtask sequence generation unit 36 generates a subtask sequence Sr, based on the control input information Ic supplied from the control input generation unit 35 and the subtask information I4 stored in the application information storage unit 41. In this case, the subtask sequence generation unit 36 recognizes a subtask that is receivable by the robot 5, by referring to the subtask information I4, and converts the control input for each time step indicted by the control input information Ic to a subtask.

For example, when pick-and-place is the target task, functions indicating two subtasks, i.e., a movement (reaching) of the robot hand, and holding (grasping) of the robot hand, are defined in the subtask information I4 as subtasks that are receivable by the robot 5. In this case, a function “Move” representing the reaching is, for example, a function in which the initial state of the robot 5 before the execution this function, the final state of the robot 5 after the execution of the function, and a necessary time for the execution of the function, are arguments. In addition, a function “Grasp” representing the grasping is, for example, a function in which the state of the robot 5 before the execution of this function, the state of the target object that is the target of grasping before the execution of the function, and the logical variable δ, are arguments. Here, the function “Grasp” represents that the operation of grasping is performed when the logical variable δ is “1”, and that the operation of releasing is performed when the logical variable δ is “0”. In this case, the subtask sequence generation unit 36 determines the function “Move”, based on a locus of the robot hand determined by the control input in each time step indicated by the control input information Ic, and determines the function “Grasp”, based on the transition of the logical variable δ in each time step indicated by the control input information Ic.

Further, the subtask sequence generation unit 36 generates the control signal S3 indicating a subtask sequence composed of the function “Move” and the function “Grasp”. For example, when the target task is “the target object (i=2) finally exists in the region G”, the subtask sequence generation unit 36 generates a subtask sequence of the function “Move”, function “Grasp”, function “Move” and function “Grasp”, for a robot hand that is closest to the target object (i=2). In this case, the robot hand closest to the target object (i=2) moves to the position of the target object (i=2) by the first-time function “Move”, grasps the target object (i=2) by the first-time function “Grasp”, moves to the region G by the second-time function “Move”, and places the target object (i=2) in the region G by the second-time function “Grasp”.

In addition, the subtask sequence generation unit 36 transmits the control signal S3 to the sequence display unit 76 of the sequence processing device 3. This aims at confirming, by the eye of a person, a subtask sequence by a robot model of the same kind as the robot 5 that is set in advance, after transmitting the control signal S3 to the sequence display unit 76 of the sequence processing device 3, before transmitting the control signal S3 to the robot 5 and actually operating the robot 5. If the control signal S3 is supplied to the sequence display unit 76 of the sequence processing device 3, the robot model of the same kind as the robot 5 displayed on the sequence display unit 76 of the sequence processing device 3 operates in accordance with the generated subtask sequence. This operation can repeatedly be confirmed. Furthermore, the viewpoint can be rotated and parallel-shifted in three-dimensional directions during the operation, and the operation of the robot in the operation space by the subtask sequence can confirmed by a desired viewpoint.

### (5-7) Attribute Information Processing Unit

The attribute information processing unit 37 generates the modification information Ir, based on the attribute signal S5 generated by the attribute signal generation unit 75 of the sequence processing device 3, and the attribute information I7 stored in the application information storage unit 41. In this case, by referring to the attribute information I7, the attribute information processing unit 37 recognizes a combination of the object selected by the user in the sequence processing device 3 and the attribute selected by the user, and generates the modification information Ir for modifying the abstract state in accordance with the combination of the object and the attribute.

For example, in the example of FIG. 14, in the task of moving the target object 61d to the region G, by newly generating a virtual obstacle 62b, it becomes possible to newly generate a plan of moving the target object 61d to the region G while avoiding the virtual obstacle 62b.

In the example illustrated in FIG. 14, the attribute information processing unit 37 is supplied with the attribute signal S5 including the information “the attribute of an obstacle is imparted to the object Ov depicted by the user” from the attribute signal generation unit 75 of the sequence processing device 3.

Further, by referring to the attribute information I7, the attribute information processing unit 37 generates, based on the information of the attribute signal S5, the modification information Ir “the virtual obstacle 62b is newly generated at a specific position in the operation space”. With the modification information Ir being supplied to the abstract state setting unit 31, an abstract state of “the virtual obstacle 62b is disposed in the operation space from the beginning” can newly be set.

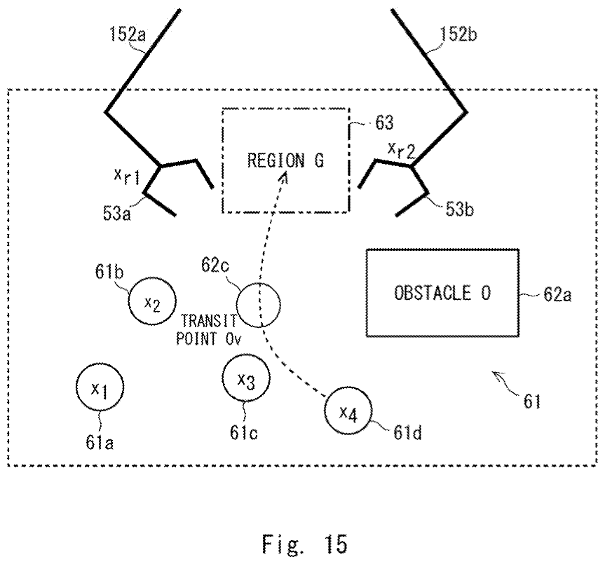

In addition, in the example of FIG. 15, in the task of moving the target object 61d to the region G, a transit point 62c is newly generated, and thereby a plan of moving to the region G via the transit point 62c can newly be generated.

Further, in the example of FIG. 15, the attribute information processing unit 37 is supplied with the attribute signal S5 including the information “the attribute of a transit point is imparted to the object Ov depicted by the user” from the attribute signal generation unit 75 of the sequence processing device 3. Besides, by referring to the attribute information I7, the attribute information processing unit 37 generates, based on the information of the attribute signal S5, the modification information Ir “the transit point 62c is newly generated at a specific position in the operation space”. With the modification information Ir being supplied to the abstract state setting unit 31, an abstract state of “the transit point 62c is set in the operation space from the beginning” can newly be set.

### (6) Details of the Process of Each Block of the Sequence Processing Device

Next, using concrete examples, a description is given of the details of the process of each functional block of the sequence processing device 3 illustrated in FIG. 10.

### (6-1) Control Signal Processing Unit

Upon receiving the control signal S3 indicating the subtask sequence from the robot controller 1, the control signal processing unit 71 generates a plan display signal Ss for displaying a plan of a subtask sequence, and supplies the plan display signal Ss to the sequence display unit 76. In addition, upon receiving a control signal from the robot controller 1, the control signal processing unit 71 generates an input reception signal Si for receiving an input from the user, and supplies the input reception signal Si to the input reception unit 72. The input reception signal Si also includes information such as position vectors, shapes and the like of the robot, obstacle, and target object in the operation space, and other objects constituting the operation space. Besides, the control signal processing unit 71 can store the received control signal S3 without returning the received control signal S3. Furthermore, upon receiving the signal Sa for operating the robot 5 from the input reception unit 72, the control signal processing unit 71 transmits the stored control signal S3 to the robot 5 as such, thus being able to execute the robot operation along the subtask sequence.

### (6-2) Input Reception Unit

The input reception unit 72, when supplied with the input reception signal Si from the control signal processing unit 71, enables an operation by the user on the screen. Specifically, the input reception signal Si also includes information such as position vectors, shapes and the like of the robot, obstacle, and target object in the operation space, and other objects constituting the operation space, and an operation reflecting these pieces of information is enabled by executing a conversion process in the input reception unit.

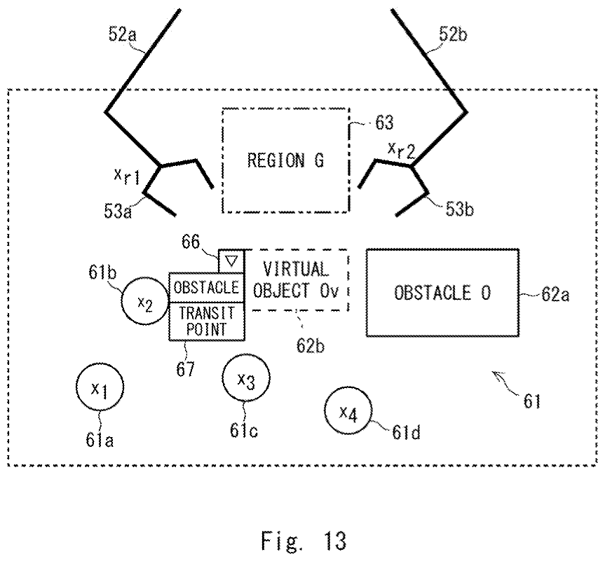

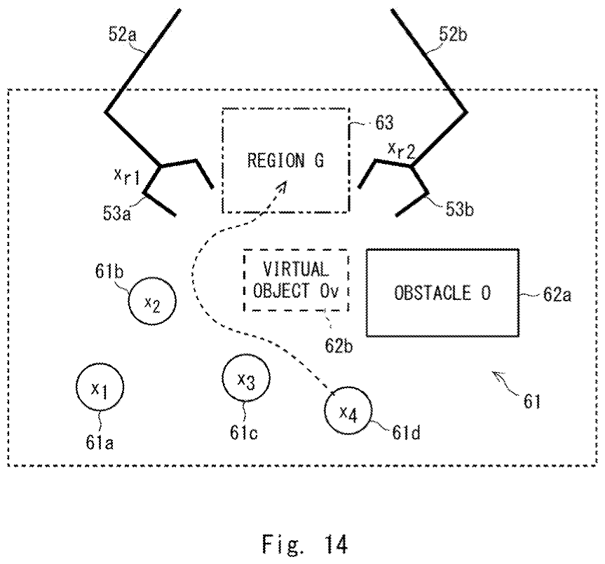

For example, FIG. 13 illustrates a screen at a time of the sequence process in the third example embodiment. At this time, the user can depict a virtual object Ov on the screen at such a position as not to interfere with other objects by using an input device such as a mouse. Thereafter, near the virtual object Ov, an icon (an icon of an inverted triangle in FIG. 13) that enables attribute selection is displayed, and, if the icon is selected on the screen, one of two attributes, i.e., “obstacle” or “transit point”, can be selected. At this time, if “obstacle” is selected, the virtual object Ov is regarded as a newly generated obstacle. On the other hand, if “transit point” is selected, the virtual object Ov is regarded as a newly generated transit point. When the virtual object Ov is regarded as a transit point, that the robot moves via the inside of the region of the virtual object Ov is imposed as a constraint condition.

In addition, the input reception unit 72 generates the input display signal Sr for displaying the content, which is input by the user, on the screen in real time, and transmits the input display signal Sr to the sequence display unit 76. Thereby, such operations as the depiction of the virtual object on the screen, the selection of the object or virtual object, or the selection of the attribute, can be displayed in real time.

Further, when such an operation as depicting an object or selecting an object on the screen is executed by the user, the input reception unit 72 generates the object selection signal So indicating that the object has been selected on the screen, and supplies the object selection signal So to the object information acquisition unit 73.

Moreover, when such an operation as selecting an attribute on the screen is executed by the user, the input reception unit 72 generates an attribute selection signal Sp indicating that the attribute has been selected on the screen, and supplies the attribute selection signal Sp to the attribute information acquisition unit 74.

Besides, the input reception unit 72 generates an operation signal Sa for operating the robot 5 in accordance with the user's instruction, and supplies the operation signal Sa to the control signal processing unit 71. Specifically, on the screen, a choice for determining whether or not to operate the robot along the subtask sequence is displayed, and, by the selection by the user, whether or not to execute the robot operation is determined. If the input reception unit 72 receives an input indicating the execution of the robot operation by the user, the input reception unit 72 generates the operation signal Sa, and supplies the operation signal Sa to the control signal processing unit 71, and thereby the robot operation is executed. On the other hand, if the input reception unit 72 receives an input indicating that the robot operation is not executed, the input reception unit 72 receives an input relating to the sequence process, thus enabling such operations as the depiction of a virtual object in the operation space, the selection of an object, and the selection of the attribute that is set for each object.

### (6-3) Object Information Acquisition Unit

The object information acquisition unit 73, when supplied with the object selection signal So from the input reception unit 72, acquires, from the application information storage unit 41, the object selection information Io that is the object model information I6 corresponding to the selected object and represents the information of the object selected on the screen by the user, and the object selection information Io is supplied to the attribute signal generation unit 75. The object selection information Io includes the information relating to the object, such as the position vector (for example, x, y coordinates) of the selected object, the shape of the object (for example, rectangular, circular, cylindrical, spherical), and the kind of object (type of object, or real object or virtual object). For example, in the example of FIG. 13, when the virtual object Ov is selected, the information of Ov, such as “values of position vectors of vertices”, “rectangular” and “depicted object”, is acquired. In addition, in some example embodiments, the object information acquisition unit 73 may recognize the object by executing an image recognition technology on the photograph image by a camera, thereby acquiring the object information.

### (6-4) Attribute Information Acquisition Unit

The attribute information acquisition unit 74, when supplied with the attribute selection signal Sp from the input reception unit 72, acquires, from the application information storage unit 41, the attribute selection information Ip representing the information of the attribute selected on the screen by the user. The acquired attribute selection information Ip is supplied to the attribute signal generation unit 75. For example, in the example of FIG. 13, the selected attribute of either “obstacle” or “transit point” is acquired.

### (6-5) Attribute Signal Generation Unit

Based on the object selection information Io and the attribute selection information Ip, the attribute signal generation unit 75 generates the attribute signal S5 indicating the information in which the acquired information of the object and the acquired information of the attribute are combined. By being supplied to the attribute information processing unit 37, the attribute signal S5 can notify the robot controller 1 of the information indicating that “a specific attribute is imparted to the specific object selected by the user.” For example, in the example of FIG. 13, the attribute signal generation unit 75 generates the attribute signal S5 indicating that “the attribute of an obstacle is imparted to the virtual object Ov existing at the depicted position.”

### (7) Details of the Display Screen

A description is given of the information that is output to the sequence display unit 76 of the sequence processing device 3.

FIG. 12 illustrates a display example of a plan before a sequence process in the third example embodiment. This display example is a first display that is displayed by the display signal Ss being supplied to the sequence display unit 76 from the control signal processing unit 71. In FIG. 12, a plan 64d that is a plan of the subtask sequence is displayed on the work bird's-eye view of FIG. 11. After the plan 64d is confirmed on the screen by the user, an input for determining whether or not to supply the operation signal Sa for executing the operation of the robot to the control signal processing unit 71 is executed on the screen in the input reception unit 72.

FIG. 13 illustrates a display example of a plan during the sequence process in the third example embodiment. This display example is a display example at a time when an object 62b is depicted by the user after an input indicating that the operation of the robot is not executed is received by the input reception unit 72. At this time, if the depicted object 62b is selected, an icon 66 for enabling attribute selection is displayed near the object 62b, and, if the icon 66 is selected, a window 67 indicating attributes is displayed. In the first example embodiment, a plurality of attributes, “obstacle” and “transit point”, are displayed on the window 67, and, if either of the attributes is selected on the screen, the information of the selected attribute is acquired by the attribute information acquisition unit 74.

### (7) Process Flow

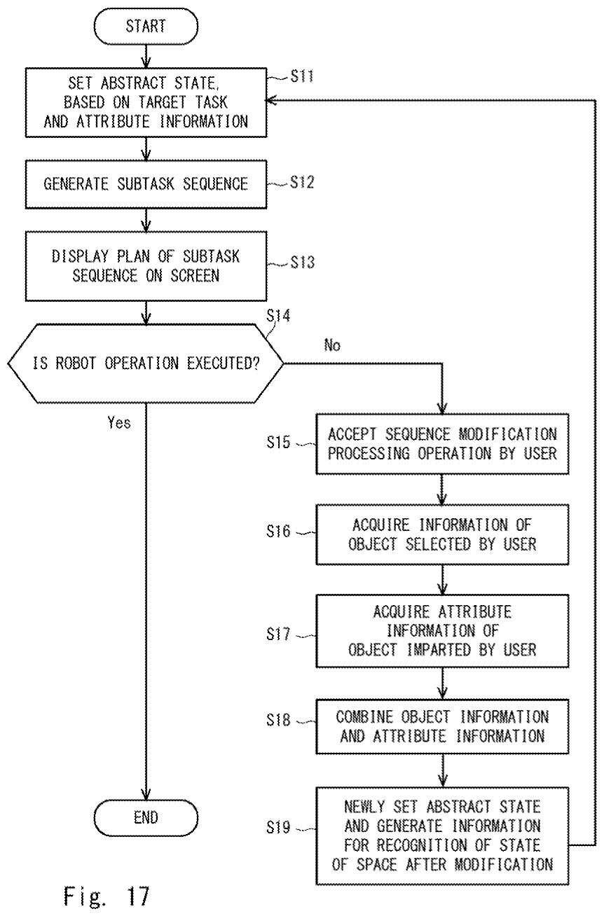

FIG. 17 is an example of a flowchart illustrating an outline of a process of a subtask sequence that is executed by the sequence processing device 3 and robot controller 1 in the third example embodiment.

To start with, based on the output signal S6 supplied from the measuring device 6, the abstract state setting unit 31 of the robot controller 1 executes the generation of the measurement information Im indicating the measurement result of the object in the operation space, and executes the setting of the abstract state (step S11). Next, the control input S3 of the subtask sequence is generated by the processing of the target logical expression generation unit 32, time step logical expression generation unit 33, abstract model generation unit 34, control input generation unit 35 and subtask sequence generation unit 36 of the robot controller 1 (step S12).

Next, the signal Ss for displaying the subtask sequence is generated by the control signal processing unit 71 of the sequence processing device 3, and a plan of the subtask sequence is displayed on the screen by the sequence display unit (step S13). Then, in a case where the plan of the subtask sequence is a desired plan for the user, if the user gives an instruction by using the input device, the signal Sa for executing the operation of the robot is generated by the input reception unit 72 and supplied to the control signal processing unit 71. Thereafter, the control signal S3 is supplied to the robot 5, and the robot operation is executed (step S14; Yes).

On the other hand, in a case where the user judges that a modification process operation of the subtask sequence is necessary, if the user gives an instruction by using the input device, the input reception unit 72 accepts, in the case of “No” in step S14, a sequence modification process operation by the user (step S15).

Next, in a case where a specific object is selected on the screen by the user, the object information acquisition unit 73 receives the object selection signal So, and acquires the object selection information Io that corresponds to the object selection signal So and represents the information of the object, such as the position vector of the selected object, the shape, and the kind of the object (step S16). Further, in a case where the attribute is selected on the screen by the user, the attribute information acquisition unit 74 receives the attribute selection signal Sp, and acquires the attribute information Ip that corresponds to the attribute selection signal Sp and represents the information of the selected attribute (step S17). Then, based on the object selection information Io and the attributed selection information Ip, the attribute signal generation unit 75 generates the attribute signal S5 indicating the information in which the acquired information of the object and the acquired information of the attribute are combined (step S18). The generated attribute signal S5 is supplied to the robot controller 1.

Then, based on the attribute signal S5 generated by the attribute signal generation unit 75 of the sequence processing device 3 and the attribute information I7 stored in the application information storage unit 41, the attribute information processing unit 37 of the robot controller 1 newly sets the abstract state, and generates the modification information Ir that is necessary for the recognition of the state of the operation space after modification (step S19). Thereafter, the process of the flowchart returns to step S11.

Based on the modification information Ir supplied from the attribute information processing unit 37 and the output signal S6 supplied from the measuring device 6, the abstract state setting unit 31 updates the generation of the measurement information Im indicating the measurement result of the object in the operation space, and the setting of the abstract state (step S11). Thereafter, as described above, each of steps S12, S13 and S14 is executed.

Although the flowchart of FIG. 17 illustrates a concrete order of execution, the order of execution may differ from the illustrated mode. For example, the order of execution of two or more steps may be changed from the illustrated order. In addition, two or more successive steps in FIG. 17 may be executed simultaneously or partly simultaneously. Besides, in some example embodiments, one or a plurality of steps illustrated in FIG. 17 may be skipped or omitted.

As described above, the sequence processing device (modification device) 3 and the robot controller 1 cooperate and control the operation of the robot 1. Accordingly, the above-described functional blocks of the robot controller and the functional blocks of the sequence processing device are merely exemplarily illustrated. In other example embodiments, some or all of the functional blocks of the sequence processing device (modification device) 3 may be included as functions of the robot controller 1, or vice versa.

### Fourth Example Embodiment

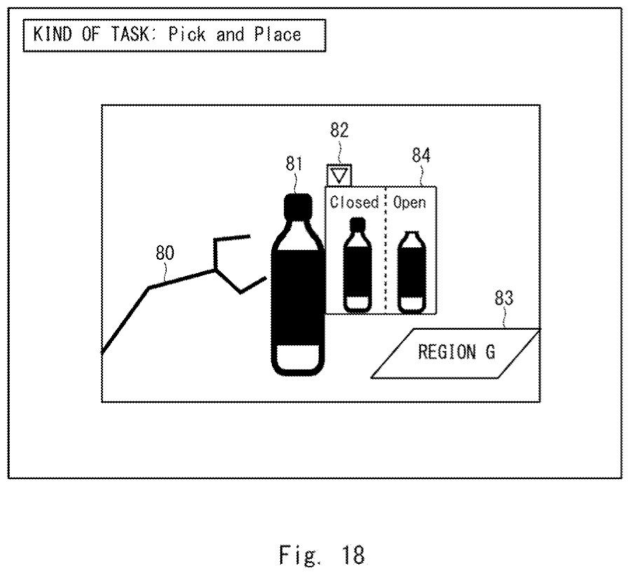

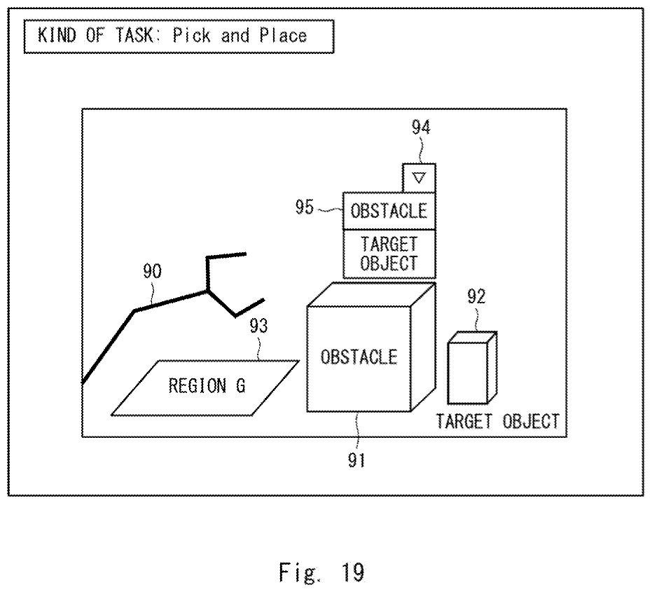

FIG. 18 illustrates an example of a screen during sequence modification by the sequence processing device 3 in a fourth example embodiment. The task displayed in FIG. 18 is a task of pick-and-place of “carrying a PET bottle 81 to a region G” by a robot arm 80, and, in this example, the purpose is to achieve a desired task by imparting an attribute relating to the state of the target object. Specifically, attributes of “Open” and “Closed” are imparted to the PET bottom 81 having a cap, and, after the state is changed to a state corresponding to a selected attribute, the task of pick-and-place is executed. Whether the cap of the PET bottom is opened or closed cannot be determined even by the measuring device 6. Thus, by imparting the attribute of “Open” or “Closed” by the user, the operation sequence of the robot is properly modified, and a desired task by the robot can be achieved. The attribute of “Open” indicates such information that although a cap is attached to a PET bottle, the cap is not completely closed since the cap is once opened by the user or the like. In other words, it is indicated that the robot can execute a task (for example, “open”) relating to the cap. On the other hand, the attribute of “Closed” indicates that since the cap is attached to the PET bottle in the completely closed state, the robot cannot execute a task (for example, “open”) relating to the cap. The attribute information relating to the present example embodiment may also depend on the relationship between the robot and the target object.

For example, if the PET bottle 81 is selected on the screen by the user, the input reception unit 72 of the sequence processing device 3 receives an input. Then, an icon 82 that enables attribute selection and a window 84 that enables visual understanding of the state of the PET bottle 81 are displayed near the PET bottle 81. Further, if the user selects the icon on the screen, the user can select two attributes of “Open” and “Closed”. At this time, if “Open” is selected, a new task of “open the cap of the PET bottle 81” for the robot can be generated. Specifically, such a plan can be generated that after the task of “open the cap of the PET bottle 81”, a task of “carry the PET bottle 81 to the region G” is executed in a stepwise manner. On the other hand, if “Closed” is selected, the task relating to the cap is not executed when the cap is attached to the PET bottle 81, and only the task of “carry the PET bottle 81 to the region G” is executed.

For example, in the example of FIG. 18, in the case where the initial state of the PET bottle is the “state in which the cap is opened”, if “Closed” is selected, the task of “carrying the PET bottle 81 to the region G” is executed after the task of “close the cap of the PET bottle 81”. On the other hand, if “Open” is selected, the task relating to the cap is not executed, and only the task of “carrying the PET bottle 81 to the region G” is executed.

In the fourth example embodiment, the task of opening and closing the cap of the PET bottle was taken as an example for achieving a desired task by imparting the attribute relating to the state of the target object. As another example, in the case of a door, if the state of the target object, such as “open” or “closed”, can visually be determined, it is assumed that such a case is included in the present example embodiment.

### Fifth Example Embodiment

FIG. 19 illustrates an example of a screen during sequence modification by the sequence processing device 3 in a fifth example embodiment. The task displayed in FIG. 19 is a task of pick-and-place of “carry a target object 92 to a region G” by a robot arm 90. In this example, the purpose is to achieve a desired task by imparting an attribute relating to the kind of the object in the operation space. In the situation of the example of FIG. 19, when a task of pick-and-place of the target object 92 is executed, since there is a possibility of contact with a large obstacle 91 disposed nearby, a tip portion of the robot arm 90 cannot be moved to the position of the target object 92. Thus, an attribute is imparted to the obstacle 91, in order to execute the task of “carry the target object 92 to the region G” after executing the task of “move the obstacle 91”. Specifically, by imparting the attribute of “obstacle” or “target object” to the obstacle 91, the kind of the obstacle 91 is changed to a kind corresponding to a selected attribute, and then the task of pick-and-place is executed. The attribute of “obstacle” indicates that the object is immovable, and the attribute of “target object” indicates that the object is movable. The attribute information relating to the present example embodiment may also depend on the relationship between the robot and the target object.

For example, the obstacle 91 is selected on the screen by the user, and the input reception unit 72 of the sequence processing device 3 receives an input. Then, an icon 94 that enables attribute selection and a window 95 indicating attributes of the obstacle 91 are displayed near the obstacle 91, and, if the user selects the icon on the screen, the two attributes of “obstacle” and “target object” can be selected. At this time, if “target object” is selected, the obstacle 91 can be regarded as a target object 91. Thereby, a new task of “move the target object 91” can be generated. In other words, such a plan can be generated that after the task of “move the target object 91”, a task of “carry the target object 92 to the region G” is executed in a stepwise manner. On the other hand, if “obstacle” is selected, the kind of the object that is “obstacle 91” is unchanged as “obstacle”, resulting in the unfeasibility of the task of “carry the target object 92 to the region G”.

In the above-described various example embodiments, the user imparts the attribute information relating to the object, and thereby the attribute, which cannot be specified even by the measuring device or the like, can be imparted to the object. Therefore, in order for the robot to achieve a target task, a more flexible plan can be generated.

In some example embodiments, an information processing device or information processing method displays a space in which a robot operates, and a plurality of attribute candidates relating to an object or a virtual object in the space, and sets an attribute candidate selected from the attribute candidates as an attribute of the object or the virtual object.

### Other Example Embodiments

Note that the above example embodiments were described as the hardware configuration, but are not limited to this. The present disclosure can also be implemented by causing a CPU to execute a computer program.

In the above-described examples, the programs can be stored with use of various types of non-transitory computer-readable media, and can be supplied to the computer. The non-transitory computer-readable media include various types of tangible storage media. Examples of the non-transitory computer-readable medium include a magnetic storage medium (e.g., a flexible disc, a magnetic tape, and a hard disk drive), a magneto-optical storage medium (e.g., a magneto-optical disc), a CD-ROM (Read Only Memory), a CD-R, a CD-R/W, a DVD (Digital Versatile Disc), a semiconductor memory (e.g., a mask ROM, PROM (Programmable ROM), an EPROM (Erasable PROM), a flash ROM, and a RAM (Random Access Memory). In addition, the programs may be supplied to the computer by various types of transitory computer-readable media. Examples of the transitory computer-readable medium include an electric signal, an optical signal, and an electromagnetic wave. The transitory computer-readable medium can supply programs to the computer via a wired communication path such as an electric wire or an optical fiber, or via a wireless communication path.

Note that the present disclosure is not limited to the above example embodiments, and can be modified as appropriate within the scope of the present disclosure. In addition, the present disclosure may be implemented by combining the example embodiments as appropriate.

The present invention has been described above by referring to the example embodiments (and examples), but the present invention is not limited to the above example embodiments (and examples). Various modifications, which are understandable by a skilled person within the scope of the present invention, can be made to the configurations and details of the present invention.

A part or the whole of the above example embodiments can be described as, but not limited to, the following supplementary notes.

### (Supplementary Note 1)

An information processing device comprising:
an input reception unit configured to receive an input for modifying an operation sequence for a robot;
an object information acquisition unit configured to acquire object information indicating information on an object or a virtual object in an operation space of the robot; and
an attribute information acquisition unit configured to acquire attribute information relating to the object or the virtual object, based on the input via the input reception unit.

### (Supplementary Note 2)

The information processing device according to Supplementary note 1, further comprising:
a sequence display unit configured to display an operation sequence of the robot;
the input reception unit configured to receive a signal for executing an operation of the robot being input in regard to the display result; and
a control signal processing unit configured to transmit a control signal of the operation sequence to the robot, based on the input.

### (Supplementary Note 3)

The information processing device according to Supplementary note 1 or 2, further comprising an attribute signal generation unit configured to combine the object information and the attribute information, and generate an attribute signal in which the object information and the attribute information are combined.

### (Supplementary Note 4)

The information processing device according to any one of Supplementary notes 1 to 3, wherein the object information acquisition unit acquires information on the object or the virtual object, based on the input via the input reception unit.

### (Supplementary Note 5)

The information processing device according to Supplementary note 2, wherein the control signal processing unit converts a control signal of an operation sequence of the robot to a display signal for displaying the operation sequence, and supplies the display signal to the sequence display unit.

### (Supplementary Note 6)

The information processing device according to any one of Supplementary notes 1 to 5, wherein the input reception unit receives the input, generates a signal for displaying in real time an operation on the object or the virtual object, or an attribute of the object or the virtual object, and supplies the signal to a sequence display unit.

### (Supplementary Note 7)

The information processing device according to Supplementary note 6, wherein, when the input reception unit receives the input relating to selection of the object or the virtual object, the sequence display unit selectively displays a plurality of attributes of the object or the virtual object.

### (Supplementary Note 8)

The information processing device according to any one of Supplementary notes 1 to 7, wherein the attribute information is based on a relationship between the robot and the object or the virtual object.

### (Supplementary Note 9)

The information processing device according to Supplementary note 8, wherein the attribute information includes information indicating that the robot is able to pass through the virtual object, and information indicating that the robot is unable to pass through the virtual object.

### (Supplementary Note 10)

The information processing device according to Supplementary note 8, wherein the attribute information includes information indicating that the robot is able to execute a task relating to the object, and information indicating that the robot is unable to execute a task relating to the object.

### (Supplementary Note 11)

The information processing device according to Supplementary note 8, wherein the attribute information includes information indicating that the object is able to be moved by the robot, and information indicating that the object is unable to be moved by the robot.

### (Supplementary Note 12)

A modification system comprising:
a sequence display unit configured to display an operation sequence of a robot;
an input reception unit configured to receive an input for modifying an operation sequence for a robot in regard to the display result;
a control signal processing unit configured to transmit a control signal of the operation sequence to the robot, based on the input;
an object information acquisition unit configured to acquire object information indicating information on an object or a virtual object in an operation space of the robot;
an attribute information acquisition unit configured to acquire attribute information relating to the object or the virtual object, based on the input via the input reception unit;
an attribute signal generation unit configured to combine the object information and the attribute information, and generate an attribute signal in which the object information and the attribute information are combined; and
an attribute information processing unit configured to receive the attribute signal that is generated by the attribute signal generation unit and includes information of a combination of an object and an attribute, and generate modification information for modifying an abstract state indicating an operation space of a robot, based on the attribute signal and storage information being stored.

### (Supplementary Note 13)

The modification system according to Supplementary note 12, further comprising a measuring device configured to measure an operation space,
wherein the modification system includes an abstract state setting unit configured to set an abstract state in which an attribute is taken into account, based on modification information generated by the attribute information processing unit, and measurement information that is measured by the measuring device and indicates a measurement result of an operation space of the robot.

### (Supplementary Note 14)

An information processing method comprising:
receiving an input for modifying an operation sequence for a robot;
acquiring object information indicating information on an object or a virtual object in an operation space of the robot; and
acquiring attribute information relating to the object or the virtual object, based on the input.

### (Supplementary Note 15)

A non-transitory computer-readable medium storing a program that causes a computer to execute:
processing of receiving an input for modifying an operation sequence for a robot;
processing of acquiring object information indicating information on an object or a virtual object in an operation space of the robot; and
processing of acquiring attribute information relating to the object or the virtual object, based on the input.

### (Supplementary Note 16)

An information processing device configured to:
display a space in which a robot operates, and a plurality of attribute candidates relating to an object or a virtual object in the space; and
set an attribute candidate being selected from the plurality of attribute candidates as an attribute of the object or the virtual object.

### REFERENCE SIGNS LIST

1 ROBOT CONTROLLER
2 INPUT DEVICE
3 SEQUENCE PROCESSING DEVICE (MODIFICATION DEVICE)
4 STORAGE DEVICE
5 ROBOT
6 MEASURING DEVICE
10 INFORMATION PROCESSING DEVICE
41 APPLICATION INFORMATION STORAGE UNIT
71 CONTROL SIGNAL PROCESSING UNIT
72 INPUT RECEPTION UNIT
73 OBJECT INFORMATION ACQUISITION UNIT
74 ATTRIBUTE INFORMATION ACQUISITION UNIT
75 ATTRIBUTE SIGNAL GENERATION UNIT
76 SEQUENCE DISPLAY UNIT
100 ROBOT CONTROL SYSTEM (MODIFICATION SYSTEM)

What is claimed is:

1. An information processing device comprising:
at least one memory storing instructions, and
at least one processor configured to execute the instructions to;
receive an input for modifying an operation sequence for a robot;
and
acquire attribute information relating to an object or a virtual object in an operation space of the robot, based on the input via the input reception.

2. The information processing device according to claim 1, wherein the at least one processor configured to execute the instructions to;
display an operation sequence of the robot;
receive a signal for executing an operation of the robot being input in regard to the display result; and
transmit a control signal of the operation sequence to the robot, based on the input.

3. The information processing device according to claim 1, wherein the at least one processor configured to execute the instructions to;
combine the object information and the attribute information, and generate an attribute signal in which the object information and the attribute information are combined.

4. The information processing device according to claim 1, wherein the at least one processor configured to execute the instructions to;
acquire information on the object or the virtual object, based on the input via the input reception.

5. The information processing device according to claim 2, wherein the at least one processor configured to execute the instructions to;
convert a control signal of an operation sequence of the robot to a display signal for displaying the operation sequence, and supply the display signal to a display unit.

6. The information processing device according to claim 1, wherein the at least one processor configured to execute the instructions to;
receive the input, generate a signal for displaying in real time an operation on the object or the virtual object, or an attribute of the object or the virtual object, and supply the signal to display unit.

7. The information processing device according to claim 6, wherein, when receiving the input relating to selection of the object or the virtual object is received, the display unit selectively displays a plurality of attributes of the object or the virtual object.

8. The information processing device according to claim 1, wherein the attribute information is based on a relationship between the robot and the object or the virtual object.

9. The information processing device according to claim 8, wherein the attribute information includes information indicating that the robot is able to pass through the virtual object, and information indicating that the robot is unable to pass through the virtual object.

10. The information processing device according to claim 8, wherein the attribute information includes information indicating that the robot is able to execute a task relating to the object, and information indicating that the robot is unable to execute a task relating to the object.

11. The information processing device according to claim 8, wherein the attribute information includes information indicating that the object is able to be moved by the robot, and information indicating that the object is unable to be moved by the robot.

12-13. (canceled)

14. An information processing method comprising:
receiving an input for modifying an operation sequence for a robot;
and
acquiring attribute information relating to an object or a virtual object in an operating space of the robot, based on the input.

15. A non-transitory computer-readable medium storing a program that causes a computer to execute:
processing of receiving an input for modifying an operation sequence for a robot;
and
processing of acquiring attribute information relating to an object or a virtual object in an operating space of the robot, based on the input.

16. (canceled)

17. The information processing device according to claim 1, wherein the at least one processor configured to execute the instructions to acquire object information indicating information on an object or a virtual object in an operation space of the robot.

18. The information processing method according to claim 14, further comprising:
acquiring object information indicating information on an object or a virtual object in an operation space of the robot.

19. The non-transitory computer-readable medium according to claim 15, wherein the program that causes a computer to execute:
processing of acquiring object information indicating information on an object or a virtual object in an operation space of the robot.
